(19) United States
(12) Patent Application Publication
(10) Pub. No.: US 2026/0250085 A1
(43) Pub. Date: Aug. 27, 2026

(54) DOCK CONTROLLERS AND LOADING DOCK AREA MANAGEMENT SYSTEMS AND METHODS

(71) Applicant: THE CHAMBERLAIN GROUP LLC, OAK BROOK, IL (US)

(72) Inventors: Chase Bussie, Hartford, WI (US); Jeremy Abel, Algonquin, IL (US); Sunil Kalavathi, Sussex, WI (US); Eric Lay, Oconomowoc, WI (US); Michael Beaster, Port Washington, WI (US); Nathaniel Shoener, Germantown, WI (US)

(21) Appl. No.: 19/549,685

(22) Filed: Feb. 25, 2026

Related U.S. Application Data
(60) Provisional application No. 63/763,436, filed on Feb. 26, 2025.

(51) Int. Cl. B65G 69/28; G06T 5/50; H04N 7/18

(52) U.S. Cl. CPC B65G 69/2882; G06T 5/50; H04N 7/181

(57) ABSTRACT

A dock controller for a loading dock environment, the dock controller including: a base; a cover coupled to the base, the base and cover defining an internal volume; control circuitry disposed in the internal volume, the control circuitry configured to affect control of loading dock component in the loading dock environment; and a camera disposed within the internal volume and configured to capture a field of view (FOV) of the loading dock environment.

### CROSS-REFERENCE TO RELATED APPLICATIONS

The present application claims priority to U.S. Provisional Patent Application Ser. No. 63/763,436 filed on Feb. 26, 2025, the disclosure of which is incorporated by reference herein in its entirety.

### FIELD

The present disclosure relates generally to dock controllers and associated systems and methods for use at loading docks and other commercial environments including movable barriers and associated components.

### BACKGROUND

Shipping goods between endpoints relies on a robust network of shipping nodes including seaports, airports, railyards, loading docks, warehouses, and the like. Goods are rarely transported by a single vehicle throughout the entire duration of shipment. Instead, goods are frequently loaded and offloaded between freight trailers, shipping containers, airplanes, rail cars, sea faring vessels, and the like at various shipping nodes. Between various segments of the journey, goods may be offloaded from one vehicle and stored in a warehouse or moved between different containers based on endpoint location.

Shipping nodes are expected to handle high volumes of traffic, including vehicle drivers and their vehicles coming and going on a regular basis, loading dock personnel and equipment moving goods between vehicles and warehouses, and millions of tons of freight being loaded and offloaded from individual trailers and containers.

Shipping nodes typically include entry points, often referred to as loading docks, through which all of the freight must pass when being loaded and offloaded from vehicles. Loading docks utilize heavy equipment, such as forklifts, operated by loading dock personnel to repeatedly pass into and out of the vehicle trailer while carrying pallets and other heavy containers of freight.

Loading docks are equipped with various loading components to facilitate easier loading and offloading of the freight. Each loading dock typically includes an entrance (or opening) passing through a wall of the facility. The opening is selectively closed by a movable barrier which secures the facility when no vehicle is present at the loading dock. When a vehicle arrives, the movable barrier must be opened to permit loading dock personnel and equipment to load and offload the carried freight. Loading docks also include components to allow heavy equipment easier access to the freight. For example, loading docks may include dock levelers which buffer the trailer floor height with the height of the loading dock to provide a smooth transition between the trailer and the loading dock for heavy equipment to traverse. Loading docks also include ample safety equipment to prevent damage to the freight as well as loading dock personnel and equipment. Typical safety equipment includes vehicle restraints, notification and lighting modules, alarms, and the like.

Traditionally, the equipment at the loading dock has been operated independently by loading dock personnel using controllers associated with each of the loading dock components. There is no centralized controller capable of managing the loading dock area and activities associated therewith while also monitoring the loading dock area. Thus, each piece of equipment is manually controlled from separate controllers, each of which requires separate training and individualized attention and servicing.

Accordingly, improved dock controllers are desired in the art. In particular, dock controllers, systems, and methods which provide centralized control of the loading dock area would be advantageous.

### BRIEF DESCRIPTION

Aspects and advantages in accordance with the present disclosure will be set forth in part in the following description, or may be obvious from the description, or may be learned through practice of the technology.

In accordance with one embodiment, a dock controller for a loading dock environment is provided. The dock controller includes a base; a cover coupled to the base, the base and cover defining an internal volume; control circuitry disposed in the internal volume, the control circuitry configured to affect control of loading dock component in the loading dock environment; and a camera disposed within the internal volume and configured to capture a field of view (FOV) of the loading dock environment.

In accordance with another embodiment, a loading dock environment is provided. The loading dock environment includes a first movable barrier operator having a first motor configured to drive a first movable barrier between an open position and a closed position; a second movable barrier operator having a second motor configured to drive a second movable barrier between an open position and a closed position; a first dock controller operatively coupled to the first movable barrier operator to affect operation of the first motor; and a second dock controller operatively coupled to the second movable barrier operator to affect operation of the second motor; wherein the first and second dock controllers each includes a camera disposed in an internal volume of the respective dock controller, wherein each camera is configured to capture a field of view (FOV) of the loading dock environment, and wherein the FOVs at least partially overlap one another.

In accordance with another embodiment, a method of operating a dock controller in a loading dock environment is provided. The method includes capturing image data, via a camera disposed in an internal volume of a dock controller, associated with the loading dock environment; analyzing, by a processor of the dock controller or a remote computing device, the image data to detect occurrence of an issue at the loading dock environment; generating, by the processor, a notification in response to a detected issue; and displaying, via a display of the dock controller, the notification, the image data, or a combination thereof.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a schematic perspective view of a loading dock area including various loading dock components in accordance with embodiments of the present disclosure;

FIG. 2 is a front perspective view of a dock controller for use at the loading dock area of FIG. 1 in accordance with embodiments of the present disclosure;

FIG. 3 is a rear perspective view of the dock controller of FIG. 2 in accordance with embodiments of the present disclosure;

FIG. 4 is a front plan view of the dock controller of FIG. 2 in accordance with embodiments of the present disclosure;

FIG. 5 is a front perspective view of the dock controller of FIG. 2 as seen with a cover of the dock controller in an open position in accordance with embodiments of the present disclosure;

FIG. 6 is a perspective view of a camera mounted to a bracket, wherein the camera and bracket are receivable in an interior of the dock controller of FIG. 2 in accordance with embodiments of the present disclosure;

FIG. 7 is a perspective view of the bracket of FIG. 6 without the camera mounted therewith in accordance with embodiments of the present disclosure;

FIG. 8 is a perspective view of the bracket of FIG. 6 without the camera mounted therewith in accordance with embodiments of the present disclosure;

FIG. 9 is a lateral plan view of the bracket of FIG. 6 without the camera mounted therewith, as seen with the bracket configured to orient the camera in a first orientation, in accordance with embodiments of the present disclosure;

FIG. 10 is a lateral plan view of the bracket of FIG. 6 without the camera mounted therewith, as seen with the bracket configured to orient the camera in a second orientation different than the first orientation of FIG. 9, in accordance with embodiments of the present disclosure;

FIG. 11 is a top view of the camera mounted to the bracket of FIG. 6 as seen with the bracket mounted at an inner surface of the cover of the dock controller in accordance with embodiments of the present disclosure;

FIG. 12 is a perspective view of the bracket mounted to an inner side of the cover in a first orientation in accordance with embodiments of the present disclosure;

FIG. 13 is a perspective view of the bracket mounted to the inner side of the cover in a second orientation different from the first orientation depicted in FIG. 12 in accordance with embodiments of the present disclosure;

FIG. 14 is a top plan view of the dock controller of FIG. 2 depicting a field of view of the camera as seen in the first and second orientations depicted in FIGS. 12 and 13 in accordance with embodiments of the present disclosure;

FIG. 15 is a partially exploded side plan view of the dock controller in accordance with embodiments of the present disclosure;

FIG. 16 is an enlarged view of a field of user interfaces disposed on the cover of the dock controller, as seen with a plurality of user interfaces present in the field, in accordance with embodiments of the present disclosure;

FIG. 17 is an enlarged view of the field of user interfaces disposed on the cover of the dock controller, as seen with the plurality of user interfaces removed, in accordance with embodiments of the present disclosure;

FIG. 18 is a cross-sectional side view of a portion of the cover of the dock controller as seen along Line A-A in FIG. 16 in accordance with embodiments of the present disclosure;

FIG. 19 is an exploded view of a layer stack associated with one of the user interfaces receivable at the field of the cover in accordance with embodiments of the present disclosure;

FIG. 20 is a perspective view of the user interfaces and a user interface control board configured to electrically connect the user interfaces to processing circuitry of the dock controller in accordance with embodiments of the present disclosure;

FIG. 21 is a top plan view of a portion of a loading dock area including fields of view of a plurality of adjacent dock controller cameras in accordance with embodiments of the present disclosure;

FIG. 22 is a plan view of a display for viewing camera feed from a plurality of cameras associated with various dock controllers in accordance with embodiments of the present disclosure;

FIG. 23 is a flow chart of a method of generating a warning relating to an observable condition in accordance with embodiments of the present disclosure;

FIG. 24 is a front perspective view of a dock controller in accordance with embodiments of the present disclosure;

FIG. 25 is a front perspective view of a dock controller as seen with a cover of the dock controller in an open position in accordance with embodiments of the present disclosure; and

FIG. 26 is a simplified schematic of a wired wall controller, a movable barrier operator, and a dock controller, shown in isolation from a surrounding loading dock environment in accordance with embodiments of the present disclosure.

### DETAILED DESCRIPTION

In general, smart features described herein are intended for use at facilities including loading docks. In particular, a dock controller is described for managing and monitoring a loading dock area.

Management of the loading dock area (referred to herein interchangeably as the loading dock environment) may include management of one or more loading dock components associated with the loading dock area, such as a movable barrier operator that provides selective access to the loading dock area by driving a movable barrier between a closed position and an open position, a vehicle restraint used to secure a vehicle at a fixed location while a container (e.g., a trailer) of the vehicle is loaded and/or offloaded by loading dock personnel and/or equipment, a dock leveler that buffers a transition between the vehicle container floor and the loading dock floor, and the like. Some of the management tasks performed by the dock controller may be automated (or partially-automated). Other management tasks performed by the dock controller may be performed by loading dock personnel interacting with the dock controller.

The loading dock area may be monitored by the dock controller through the capture of data streams (captured feed) from one or more sensors. For example, monitoring of the loading dock area may be performed by a camera of the dock controller. The camera is configured to capture image data, video data, and/or audio data (via a transducer, like a microphone) from the loading dock area for immediate viewing. Alternatively, or in addition, the captured feed may be stored for later viewing. The dock controller may include a black and white display or a color display and/or a speaker for local viewing and/or listening to captured feed, a local memory to store the captured feed, and/or a wireless transceiver that transmits the captured feed to a remote computing device for external viewing and/or listening.

The dock controller may capture image and/or video data using an onboard camera disposed within a housing of the dock controller. Internally housing the camera within the dock controller reduces the potential for damage to the camera that might occur, for example, in the event the dock controller is impacted by heavy equipment entering or exiting a nearby vehicle trailer.

The camera defines a field of view (FOV) facing towards the loading dock area to capture loading dock personnel, equipment (e.g., forklifts), loading dock components, and freight as it moves through the loading dock area. The camera can define a wide-angle field of view (e.g., 140° field of view) to monitor a large portion of the loading dock area.

In a typical installation, each dock controller is associated with a single loading dock. For example, a typical loading dock area might include more than twenty-five (25) individual loading docks each separated from one another by a segment of a common wall. A separate dock controller can be positioned adjacent to each of the separate loading docks (e.g., at the wall segment separating adjacent loading docks) and associated with a respective loading dock to provide both functional control over aspects of the loading dock and monitoring of the loading dock area.

The camera may be canted (angled) towards the associated loading dock, e.g., using an adjustable bracket and/or a bracket that is repositionable between two or more different orientations relative to the dock controller. The adjustable bracket may be installed in multiple different orientations such that the same dock controller can be configured for left-hand association (where the monitored loading dock is arranged to the left of the dock controller) or for right-hand association (where the monitored loading dock is arranged to the right of the dock controller). The bracket may further allow for pitch adjustment in the vertical direction to allow for custom camera positioning based on the individual needs of the loading dock area.

In some implementations, the dock controller can further include an additional, or even a plurality of additional, integrated cameras. The additional camera(s) can be directly coupled to the dock controller or mounted therewith through one or more modular attachments. The additional camera(s) may point in a different direction from the aforementioned camera, such as e.g., in a lateral direction towards a movable barrier associated with the loading dock, an upward direction, a downward direction, or a diagonal direction therebetween.

Camera feed may be stored locally or remotely as raw data, compressed data, metadata, or a combination thereof. The camera feed may be monitored using one or more automated video analysis techniques that interpret the camera feed for incidents, including escalated events, anomalies, threshold conditions, or the like. When one or more detected incidents occur (e.g., a forklift collides with a pallet of freight), the camera feed may be automatically flagged for further review. In some instances, the camera feed is flagged using a graded flagging system denoting a corresponding level of escalation. In some implementations, camera feed can be combined with metadata, such as a timestamp, location information, or the like to provide context associated with the nature of the incident. The camera feed may be subjected to machine learning (ML) and/or large language model (LLMs) to generate summaries, e.g., a textual summary, of the incident. The flagged camera feed may be forwarded to a remote computing device and/or displayable on a screen of the dock controller. Users, such as loading dock personnel, onsite managers, and the like can interact with the flagged camera feed to better understand the nature of the incident. In some instances, the tagged incident may initiate playback some duration prior to the detected incident to provide contextual information regarding a period of time leading up to the incident.

In some instances, the dock controller includes integrated memory hardware capable of storing the camera feed, a portion of the camera feed, or information associated therewith. For example, the dock controller can include a memory card coupled to the camera. The memory card may be removable from the dock controller under certain conditions, such as when a cover of the dock controller is in the open position. When an incident occurs, the memory card may be removed and provided to third parties for more detailed review and analysis. To conserve memory capacity, the camera feed may be circularly buffered, e.g., using a first-in-first-out (FIFO) methodology.

The dock controller may be configured to capture image data at a relatively high quality, such as 1080p or even 4K. In some implementations, the dock controller can capture images at multiple different qualities. When no incident is detected (and after a threshold period of time), the dock controller may modify and/or select between different levels of quality. For example, the dock controller can convert high-quality image data to a lower image quality, or even delete the high-quality image data and replace the high-quality image data with a lower quality version, in order to reduce memory requirements. Where an incident is detected, the dock controller may retain the higher quality image data to provide greater contextual information regarding the nature of the incident.

In some implementations, the fields of view (FOV) of individual cameras associated with adjacent dock controllers can overlap one another. In an embodiment, the camera feed of multiple dock controllers can be stitched together to generate a combined camera feed.

In some implementations, the camera feed of one dock controller can be used to interlock (e.g., prohibit) activity controlled by another dock controller. For example, where the camera feed of a first dock controller detects that a pallet is obstructing a second loading dock camera, the first dock controller can communicate with the second dock controller to notify the second dock controller of the issue, to interlock the second dock controller from performing one or more functions, to temporarily gain control over the second dock controller, or the like. Similarly, where a first dock controller recognizes that equipment and/or loading dock personnel are actively in the vehicle of an adjoining loading dock associated with a second dock controller, but that an action is to be taken by the second dock controller, such as releasing the vehicle restraint, the first dock controller may interlock the second dock controller from taking such action. In this regard, the dock controllers can work together to secure and/or manage the loading dock area. The dock controllers may communicate through wired and/or wireless communication protocols. In some instances, communication between the dock controllers can occur in real time, on an ongoing basis. In other instances, communication between the dock controllers can occur only when interlock and/or overriding of the other dock controller is warranted. For example, each of the dock controllers can broadcast a signal (wired and/or wireless) to the other dock controllers (or at least one or more nearby dock controllers) when an action is being performed. The other dock controller(s) may respond to the broadcast signal where necessary to interlock the associated behavior, e.g., in view of sensor data obtained at the other dock controller(s) which warrant interlocking of the broadcasting dock controller.

In some implementations, the camera may detect one or more coded messages that are discernable by the dock controller to perform an operation. For example, the camera may capture image data of pallets moving past the dock controller. The dock controller may discern a QR code through captured image data. In response to discerning the QR code, the dock controller can instruct certain behavior to be undertaken.

In some implementations, access to the captured feed (e.g., to view on a screen of the dock controller) may vary based on credential. For example, a first level of access credential may allow for real time viewing of the camera feed at the screen of the dock controller, a second access credential may additionally allow for real time listening to audio feed at the dock controller, a third access credential may allow for viewing of stored video and/or audio feed at the dock controller, a fourth access credential may allow for high quality viewing of stored video and/or audio feed at the dock controller, a fifth access credential may allow for remote access of the real time and/or stored audio and/or video feed, etc. Yet other access level credentials and/or access level differentiation is possible.

In some implementations, the captured feed may be used to inspect the loading dock area, or one or more portions of the loading dock area, before allowing remote credentialing and/or remote control (e.g., override) from a remote location. For example, a remotely located person (e.g., a person located in a different area of the facility or a different part of the world) may desire to perform one or more control capabilities provided by the dock controller. Before permitting the remotely located person to perform the control capabilities from a remote location, the dock controller may utilize one or more sensors, e.g., the camera of the dock controller, to capture feed associated with the loading dock area, or a portion thereof. The captured feed can be used to determine whether the remotely located person may perform the one or more control capabilities. For instance, by way of non-limiting example, where the camera feed indicates loading dock personnel is located within a prescribed distance of the movable barrier, the remotely located person may be restricted from remotely controlling the movable barrier operator. In another example, where the camera detects approaching loading dock personnel or loading dock components (e.g., a forklift), the remotely located person may be restricted from raising and/or lowering a dock leveler. In yet another example, where a vehicle restraint is determined to be engaged with a trailer (e.g., a RIG bar of the trailer) and the camera feed indicates loading dock personnel and/or loading dock component(s) is in the trailer, the remotely located person may be restricted from disengaging the vehicle restraint. The above examples are not intended to be limiting. Yet other types of remote control and/or access may be limited based on information obtained from the captured feed.

In addition to capturing camera feed of the loading dock and loading dock area, the dock controller is used to control loading dock components associated with the loading dock area. For example, the dock controller can include one or more user interfaces which allow loading dock personnel to interact with various loading dock components. The user interfaces may include, for example, buttons which are selectable by loading dock personnel to control one or more functional aspects of the loading dock component.

One example loading dock component is a movable barrier operator which controls the position of a movable barrier that selectively blocks entrance into the loading dock area through an opening in the side of the facility. The movable barrier operator may be coupled to the dock controller through a wired connection or wirelessly. When the movable barrier operator is connected to the dock controller, loading dock personnel can manage the state of the movable barrier operator using the user interface on the dock controller. The user interface can include, for example, a first button associated with raising the movable barrier, a second button associated with lowering the movable barrier, and a third button associated with stopping travel of the movable barrier. The loading dock personnel can selectively interact with the first, second, and third buttons to affect the position and state of the movable barrier.

Another example loading dock component is a vehicle restraint which includes a movable member that physically interlocks the vehicle trailer at a fixed location with respect to the facility. The vehicle restraint may be coupled to the dock controller through a wired connection or wirelessly. When the vehicle restraint is connected to the dock controller, loading dock personnel can manage the state of the vehicle restraint using the user interface on the dock controller. The user interface can include, for example, a first button associated with vehicle engagement, and a second button associated with vehicle disengagement. The loading dock personnel can selectively interact with the first and second buttons to affect the position and state of the vehicle restraint.

The dock controller can include a screen, such as a liquid crystal display (LCD) which displays information, such as the camera feed, camera feed from an exterior camera, instructions for loading dock personnel, or the like. The exterior camera may have a field of view in which the vehicle restraint, the vehicle, or other exterior components are positioned. In some implementations, the dock controller is configured to display camera feed from the exterior camera while the loading dock personnel interacts with the vehicle restraint, e.g., using the user interface on the dock controller. In some implementations, the dock controller may automatically display the camera feed from the exterior camera in response to detecting a vehicle at the exterior of the loading dock, i.e., within the field of view of the exterior camera. In other implementations, the dock controller may predict when the camera feed from the exterior camera should be displayed on the screen, e.g., by observing the vehicle completing approach at the loading dock exterior. In yet other cases, the dock controller may automatically display the camera feed from the exterior camera when the loading dock personnel interacts with the dock controller, and more particularly, when the loading dock personnel interacts with one of the buttons associated with the vehicle restraint. Yet other types of actions can cause the camera feed to be displayed on the screen of the dock controller. For example, the camera feed may be displayed when particular personnel are nearby, when an incident is detected, in response to discerning a particular QR code, etc.

Using the dock controller, loading dock personnel can inspect camera feed from the exterior camera to determine successful engagement of the restraint with the trailer or even, in the case where multiple different vehicle restraint options exist, which vehicle restraint option is being used at a given time to restrain a trailer. For example, the camera feed can be used to determine engagement of a rig bar restraint, a wheel restraint (e.g., wheel chocks), or the like. In some implementations, the dock controller can analyze camera feed from the exterior camera and automatically determine an aspect of the exterior operation, such as which restraint is engaged, which restraint is disengaged, etc. The dock controller can display information associated with the determined aspect, such as for example, “RIG Restraint Engaged”, “Wheel Chocks in Position”, “Vehicle Successfully Restrained”, or the like.

Another example loading dock component is a dock leveler which includes a movable platform that buffers height of the loading dock floor with a trailer height. When the dock leveler is connected to the dock controller, loading dock personnel can manage the state of the dock leveler using the user interface on the dock controller. The user interface can include, for example, a first button associated with raising the dock leveler, a second button associated with lowering the dock leveler, and a third button associated with stopping movement of the dock leveler. The loading dock personnel can selectively interact with the first, second, and third buttons to affect the position and state of the dock leveler.

In some implementations, the screen may display information associated with the state of the dock leveler. The displayed information may include, for example, a current angle or position of the dock leveler, sensor information associated with a pit sensor arranged at a pit of the dock leveler, an estimated remaining angular adjustment required to complete leveling, or the like.

Yet other types of loading dock components may be present at the loading dock and controlled by the dock controller.

In some implementations, the dock controller includes a field in which one or more user interfaces associated with each of the loading dock components can be positioned. In an embodiment, each loading dock component can include a unique user interface specifically for use with that loading dock component. In some instances, the individual user interfaces may be removable and/or customizable relative to the field on the dock controller. For example, the field can define individual regions in which a single user interface is receivable. The regions can be populated with the various user interfaces as shipped from the manufacturer or as part of a later retrofit of the dock controller.

In an embodiment, the dock controller includes four user interfaces disposed in the field, a first user interface associated with the vehicle restraint, a second user interface associated with the movable barrier operator, a third user interface associated with the dock leveler, and a fourth user interface that includes functionality associated with one or more auxiliary loading dock components, such as a loading dock fan and a loading dock light. Reference to the first, second, third, and fourth user interfaces is not intended to limit the order or arrangement of the user interfaces within the field.

The individual user interfaces can be attached to an exterior of the dock controller, for example, using an adhesive. In some implementations, the user interface(s) are provided with an adhesive strip pre-installed along a rear surface of the user interface. Loading dock personnel can remove a backing from the adhesive strip and press the adhesive strip against the exterior of the dock controller. Each user interface can be electrically coupled with internal circuitry of the dock controller, e.g., using a ribbon circuit. The ribbon circuit can extend from the individual user interface, through a passthrough defined in the region where the user interface is received, and interface with a connector disposed within an interior of the dock controller. In an embodiment, the connectors of the ribbon circuits can all interface with a separate connector carried by a user interface control board. By way of example, the user interface control board can include four connectors-one for each user interface.

Some loading docks may not require all four user interfaces. For example, small loading dock facilities may lack dock levelers. The associated region of the field where the dock leveler user interface is to be positioned can instead have a blank insert to cover the associated passthrough. If the loading dock facility expands to later include a dock leveler, the blank insert is removed from the region and the user interface can be attached and electrically coupled to the user interface control board.

The dock controller may automatically gain control, or begin a pairing process to gain control, of a loading dock component upon connection of the associated user interface to the dock controller. Alternatively, or in addition, the dock controller may automatically register the loading dock component upon connection of the loading dock component itself to the dock controller. For example, the dock leveler typically includes a wiring harness which extends from the dock leveler to a separate remote including interactive features for activating the dock leveler. To connect the dock leveler to the dock controller, the wiring harness itself can be detached from the separate remote and re-attached to input ports on the dock controller, a splice or connection can be installed (e.g., in the wiring harness) to connect the dock leveler to the dock controller while maintaining use of the separate remote, a wireless connection can be established between the dock leveler and the dock controller, or any combination thereof. Once connection between the dock controller and loading dock component is achieved and the associated user interface is in place and connected, the dock controller may be used in lieu of a separate remote to control one or more controllable aspects of the loading dock component.

The dock controller may permit initial provisioning with loading dock component(s). For example, when provisioning a movable barrier operator, such as during initial setup of the movable barrier operator, it is important to establish end ranges in which movement of the movable barrier is to be kept within. Setting the end ranges is done using a wired wall controller. The dock controller described herein may be configured to operate the movable barrier operator in a similar manner as the wired wall controller without requiring electrical connection of the wired wall controller to the movable barrier operator.

The dock controller may be configured to emulate other loading dock components in the loading dock area. For example, the dock controller may emulate a wired wall controller, reproducing a digital version of the wired wall controller on the display for loading dock personnel to interact with. The loading dock personnel can select features emulated by the dock controller, e.g., by selecting icons on the screen which mimic the buttons on the wired wall controller, to affect the same, or substantially similar, operation that would occur as a result of selecting the actual buttons on the wired wall controller. The dock controller may be configured to select between various emulation programs based on the particular loading dock component(s) being controlled and their various remotes.

The dock controller may be re-enterable at the loading dock area. In this regard, the dock controller may be easily serviced by an onsite technician in the event of a problem. The dock controller can include a multi-piece construction formed by a base and a cover. The base can be mounted to the wall and the cover can pivot relative to the base about an axis (e.g., a vertically oriented axis). With the cover in the open position, the technician can access internal circuitry to wire the loading dock components to the dock controller, to connect the user interface(s) to the user interface control board, to service or repair broken circuitry, or the like.

Dock controllers described herein may be retrofit at existing loading docks and integrated into existing loading dock workflows. The dock controller may reduce training requirements for new hires and existing loading dock personnel. The dock controller may provide guided instructions during a loading dock workflow. For example, the screen of the dock controller may display video, still images, animations, and/or text that directs loading dock personnel to complete a workflow. For example, when a vehicle arrives at the loading dock, the dock controller may prompt the nearby loading dock personnel to interact with the user interface associated with the vehicle restraint to lock the vehicle at a fixed location. At, or about, the same time, the user interface associated with the vehicle restraint can signal an appropriate action to take. The user interface may include one or more backlit features which become illuminated to direct use of the vehicle restraint. For example, an initial button of the user interface associated with the vehicle restraint might illuminate or flash to signal to the loading dock personnel where to press. When pressed, the illuminated button may cause the vehicle restraint to engage the vehicle. The screen of the dock controller may display video feed from an external camera while the vehicle restraint is moved to the engaged position. After the vehicle restraint successfully engages the vehicle, the dock controller may automatically turn off the video feed from the external camera and then display instructions on the screen for the next step of the workflow. The next step of the workflow might include, for example, opening of the movable barrier associated with the loading dock at which the restrained vehicle is positioned. In addition to providing guidance on the screen, an initial button of the user interface associated with the movable barrier might illuminate or flash to signal to the loading dock personnel where to press. This process can repeat for each step in the workflow, or at least some of the steps in the workflow.

The user interfaces can be arranged in chronological order associated with a most typical workflow. For example, the leftmost user interface can correspond with control of the vehicle restraint (which is typically activated first when a vehicle arrives at the loading dock). The user interface to the right of the vehicle restraint user interface can correspond to the moveable barrier operator (which is typically activated after the vehicle restraint is engaged with the vehicle). The user interface to the right of the movable barrier operator interface can correspond to the dock leveler (which is typically activated after the movable barrier operator has opened the movable barrier). Yet further functionality may be disposed between each of these user interfaces or to the right of these user interfaces.

In some implementations, the dock controller may utilize one or more identification techniques to identify an exact match or an associated grouping of nearby loading dock personnel. Example identification techniques include, for example, biometric identification, e.g., facial recognition, fingerprint recognition, body attribute recognition (e.g., estimated height, estimated weight, etc.), voice recognition, gait recognition, behavioral biometrics, retina scan, face and/or body thermography, etc. The identifying technique may also, or alternatively, include another form of identification, such as a badge scan, etc. The dock controller, and more particularly a processor associated with or in communication with the dock controller, may compare received information, such as camera feed, audio feed, badge scans, etc., against a database or other reference to determine which loading dock personnel are present and/or nearby the dock controller. In some implementations, the dock controller may further identify a specific person interacting most closely with the dock controller and/or the loading dock area. For example, the dock controller may identify the person interacting with buttons and/or control features of the dock controller. In response to identifying the nearby loading dock personnel, such as the specific person interacting most closely with the dock controller, the dock controller may automatically reconfigure to an operating mode specifically intended for that person or personnel grouping. If, for example, the loading dock is in the United States and a person interacting with the dock controller is listed in a Human Resource database as a non-native English speaker, the dock controller may automatically reconfigure to provide instructions, such as text, in a different language associated with that person. For example, in the case where the person is a native-Spanish speaker, the dock controller may automatically identify the person and add and/or replace text with Spanish text. Where audible information is communicated with the person, the audio may be translated and/or presented in the person's native language. In this regard, the dock controller may automatically configure to various different users. By way of another example, where a person identified at the dock controller is a new hire, for example the person is not yet in the database as a known person or is registered as a new hire (e.g., by hiring date, HR entry, or the like), text and other information provided by the dock controller may be supplemented with additional guidance to more granularly walk the person through a workflow. Conversely, where the person identified at the dock controller is a recognized (e.g., long term) loading dock personnel, text and other information may be less granular. The dock controller may update a ledger or database of known persons and link corresponding information, such as native language, to the person entered in the update. In some implementations, the dock controller may estimate or guess a native language or other corresponding information based on received information. For example, where a microphone of the dock controller or a nearby microphone, captures audio from a speaker in an atypical language, the dock controller, or another processor in communication with the dock controller, may identify the language and associate the person speaking the identified language with the identified language and automatically self-configure to provide guidance to that person in the identified language. By way of another example, the dock controller may identify nearby hearing impaired or visually impaired loading dock personnel and present information at the dock controller differently to accommodate the personnel. For example, instead of using the screen to display information, the dock controller may switch to, or supplement with, an audible mode where visually impaired loading dock personnel is present. In the audible mode, the dock controller may be configured to receive control instructions at a transducer (e.g., a microphone) instead of through physical contact, e.g., at the screen.

In some implementations, the dock controller may include a user input (e.g., a help button) which may be selected, e.g., by loading dock personnel, when assistance is required. The user input may be a physical button located on the dock controller. When the user input is selected (e.g., depressed, toggled, etc.), the dock controller may initiate an assistance protocol to provide assistance at the affected dock bay. The assistance protocol may include, for example, interlocking one or more control capabilities provided by the dock controller and/or at the dock bay. For example, the dock controller may restrict use of the dock controller to open and/or close the movable barrier after initiation of the assistance protocol. The assistance protocol may also, or alternatively, cause lights at the dock bay and/or dock controller to illuminate. The illuminated lights may signal that assistance is required. The assistance protocol may also, or alternatively, cause broadcast of an audible message from the dock controller or a nearby speaker to loading dock personnel at, or near, the associated dock bay. The assistance protocol may also, or alternatively, trigger transmission of an emergency message, e.g., to a remote computing device. The assistance protocol may also, or alternatively, cause the screen of the dock controller to display information to nearby loading dock personnel to assist in resolving the issue. The assistance protocol may also, or alternatively, affect data capture. For instance, the camera feed may be stored at a high-quality resolution, the camera feed may be broadcast in real-time, e.g., to a remote location for remote viewing, an onboard microphone of the dock controller may automatically activate to capture audio at the dock controller, or the like. The assistance protocol may also, or alternatively, initiate an emergency assistance mode of the dock controller and/or one or more other dock controllers at the facility. The dock controllers at the facility, or at least some of the dock controllers, may be configured to provide supplemental support to the affected dock bay and/or dock controller where the user input was received. For example, neighboring dock controller(s) may be configured to enter a reduced operating protocol to permit allocation of resources to the affected dock bay. The neighboring dock controller(s) may also, or alternatively, redirect capabilities to the affected dock bay. For example, the neighboring dock controller(s) may reorient camera fields of view towards the affected dock bay. The neighboring dock controller(s) may also display a message on their screens which causes loading dock personnel at the neighboring dock controller(s) to reroute to the affected dock bay.

The dock controller may thus allow for comprehensive management and monitoring of the loading dock area. Yet further applications may be served without deviating from the scope of the disclosure.

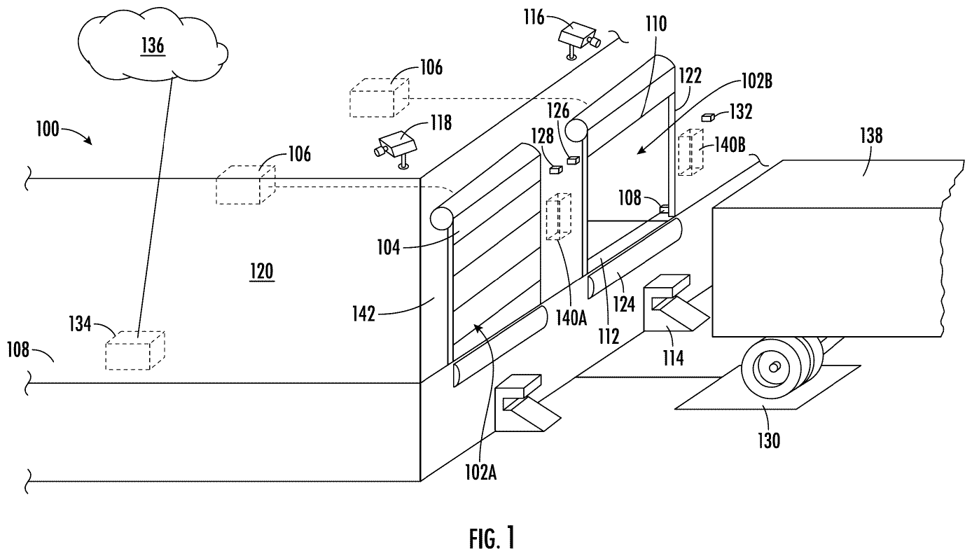

Referring now to the drawings, FIG. 1 illustrates a loading dock area 100 in accordance with an example embodiment. The loading dock area 100 includes a plurality of loading docks, such as a first loading dock 102A and a second loading dock 102B. The loading docks 102A and 102B (collectively referred to as loading docks 102) each define a separate controllable entrance to the loading dock area 100. Each of the loading docks 102 includes a movable barrier 104 selectively prohibiting access to the loading dock area 100. The movable barriers 104 are operatively connected to movable barrier operators 106 that drive the movable barriers 104 between the open and closed positions. By way of example, the movable barriers 104 can each include a roller door, a paneled door, a swinging door, a gate, or another suitable barrier for controlling access to an interior of the loading dock area 100. The depicted loading dock area 100 is intended as an exemplary environment in which systems, apparatuses, and methods described herein can be employed.

The movable barrier operators 106 may each include components, circuitry, linkages, and other features that affect operational movement of the movable barriers 104. For example, the movable barrier operators 106 can each include a motor, communication circuitry, a memory, and a processor. The motor can interface with the movable barrier 104, directly or indirectly, such that when activated, the motor drives the movable barrier 104 in a desired direction. When not actively driving the movable barrier 104, the motor can maintain the movable barrier 104 in the current state, i.e., open or closed, and prevent intruders from entering the loading dock area 100.

The loading dock area 100 may include one or more loading dock components. Example loading dock components include a photo beam system 108 including an emitter that transmits a beam across an opening in the loading dock 102 to detect movement thereacross, a safety edging of the door 110, a dock leveler 112, a vehicle restraint 114 (e.g., a trailer lock), an exterior camera 116, an interior camera 118 disposed in an interior 120 of the loading dock area 100, edge guards and/or a dock seal 122, a dock bumper 124, an optical detector 126 (e.g., a camera or light time-of-flight sensor), a sensor 128 (e.g., a passive infrared (PIR), ultrasonic, and/or microwave sensor), a loop detector 130, and a notification system 132 (e.g., a single or multi-lighted display). While the loading dock components are illustrated in particular locations relative to the loading dock area 100, one or more of the loading dock components may be alternatively, or in addition, located in a different part of the loading dock area 100. For example, the exterior camera 116 is depicted at a relatively high elevation, such as on a roof of the loading dock area 100. In some installations, the exterior camera 116 may be located closer to the ground, such as near the dock bumper 124. In yet other implementations, two exterior cameras 116 may be employed to detect events occurring at each loading dock 102. By way of another example, the interior camera 118 can include a plurality of interior cameras 118. In some instances, the interior camera(s) 118 may already exist at the facility. In other instances, one or more interior camera(s) 118 may be added to the facility as part of an upgrade associated with the inclusion of one or more loading dock component or components described herein. In some implementations, the loading dock components are reproduced at each separate loading dock 102. That is, each loading dock 102 may have its own set of loading dock components, or a combination of separate loading dock components. In other implementations, at least one of the loading dock components may provide functional capability to more than one loading dock 102, such as to two or more adjacent loading docks 102.

One or more of the loading dock components may be in communication (e.g., wired or wireless communication) with one or more of the dock door operators 106 or even a gateway device 134, such as a wireless access point or router. The gateway device 134 can communicate with a remote computing device through a network 136. The gateway device 134 may communicate with the various loading dock components and one or more of the dock door operators 106 directly or through the network 136. The gateway device 134, network 136, and or loading dock components can exchange (send or receive) signals (e.g., electronic signals), data (e.g., data from a computing device), or other information and include any combination of various wired (e.g., twisted pair cable) or wireless communication mechanisms (e.g., cellular, wireless, satellite, microwave, and radio frequency) or any desired network topology (or topologies). For example, the network 136 can include a local area network (e.g., intranet), wide area network (e.g., Internet), wireless LAN network (e.g., through Wi-Fi), cellular network, a SATCOM network, VHF network, a HF network, a WiMAX based network, or any other suitable communication network (or combination thereof) for transmitting data to or from the loading dock components or among computing systems.

The remote computing device can include one or more computing devices disposed at one or more locations, onsite or remote. The computing device(s) may operate separately or jointly. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the remote computing device (e.g., its computing system, one or more processors, etc.) to perform operations and functions, such as those described herein for managing and/or monitoring aspects of the loading dock area.

Typically, when a vehicle 138, such as a semi-trailer truck, arrives at a facility including a loading dock area 100, the vehicle operator must “check in” at a gate before the vehicle 138 is permitted to enter the facility. Upon successful check-in, the vehicle 138 may be directed to a particular loading dock 102, such as the first or second loading docks 102A, 102B depicted in FIG. 1, to load or unload freight hauled by the vehicle 138. As depicted, the vehicle operator typically approaches the loading dock area 100 by backing the vehicle 138 up to the instructed loading dock 102. Once in position, or as a final process of positioning the vehicle 138 at the loading dock 102, the vehicle restraint 114 is activated to engage with a particular component of the vehicle 138, such as a trailer rig bar. In some instances, the notification system 132 may generate a notification when the respective loading dock 102 is vacant, occupied, or even while the vehicle 138 backs up to and/or departs from the loading dock 102. In some implementations, the notification system 132 may generate a notification upon successful engagement of the vehicle restraint 114 with the vehicle 138, upon release therebetween, or both informing the vehicle operator and/or nearby loading dock workers the loading dock status.

Once the vehicle 138 is appropriately docked at the loading dock area 100, the movable barrier 104 is raised, the dock leveler 112 is re-positioned to an appropriate height corresponding to a floor of the vehicle trailer, and any other loading dock components are brought into operational use to enhance safety and security of nearby personnel and equipment. After the loading dock components are in place, loading dock area personnel may enter the vehicle trailer to load and/or unload freight therefrom.

In some implementations, a remote computing device may monitor the status of one or more of the various loading dock components arranged at the loading dock area 100 during the stay of the vehicle 138. While the remote computing device may be offsite, e.g., not associated with the physical loading dock area, it is also contemplated that the remote computing device can correspond to an onsite manger's computing system located at the loading dock facility, such as within the facility but separate from the individual loading docks 102. The remote computing device can receive information from the various loading dock components to allow personnel and/or machine learning equipment to monitor, direct, and oversee the loading and unloading process.

In some implementations, the remote computing device may not be able to affect an adjustment to the loading dock area 100 until the loading dock area 100 is cleared in view of captured feed as described below. For example, a remotely located person (e.g., a person located in a different area of the facility or a different part of the world) may desire to remotely perform one or more control capabilities at the loading dock area 100. Before permitting the remotely located person to perform the control capabilities from a remote location, sensor feed can be used to determine whether the remotely located person may perform the one or more control capabilities. For instance, by way of non-limiting example, where the sensor feed indicates loading dock personnel is located within a prescribed distance of the movable barrier 104, the remotely located person may be restricted from remotely controlling the movable barrier operator 106. In another example, where the sensor feed indicates approaching loading dock personnel or loading dock components (e.g., a forklift), the remotely located person may be restricted from raising and/or lowering a dock leveler 112. In yet another example, where a vehicle restraint 114 is determined to be engaged with a trailer (e.g., a RIG bar of the trailer) and the sensor feed indicates loading dock personnel and/or loading dock component(s) is in the trailer, the remotely located person may be restricted from disengaging the vehicle restraint 114 to release the trailer. The above examples are not intended to be limiting. Yet other types of remote control and/or access may be limited based on information obtained from the captured feed.

In accordance with embodiments described herein, the loading dock area 100 can further include one or more dock controllers 140. For example, FIG. 1 illustrates the loading dock area 100 including two separate dock controllers 140A, 140B each associated with a different loading dock 102A, 102B. In some implementations, the number of dock controllers 140 corresponds directly (e.g., 1:1) to the number of loading docks 102. Each dock controller 140 can be disposed between an adjacent pair of loading docks 102. For example, the first dock controller 140A may be disposed between the first and second loading docks 102A, 102B. The dock controller(s) 140 are generally mounted within the interior 120 of the loading dock area 100. In some implementations, the dock controller(s) 140 are mounted to an interior surface of a common wall 142 of the loading dock area 100. Mounting the dock controller 140 at the common wall 142 reduces areal footprint in the loading dock area 100 and maximizes area for equipment and freight to traverse. Alternatively, one or more of the dock controller(s) 140 can be coupled to a separate mount or stand (not illustrated) which is separate from the common wall 142.

As described in greater detail hereinafter, the individual dock controllers 140 each control functionality associated with one of the loading docks 102. In some implementations, the individual dock controllers 140 may operate independent of one another to control a respective one of the loading docks 102, such as to control the movable barrier operator 106 to reposition the movable barrier 104, the dock leveler 112, the vehicle restraint 114, another loading dock component, or any combination thereof. In other implementations, two or more of the individual dock controllers 140 can be in communication with one another and exchange information, control instructions, or the like.

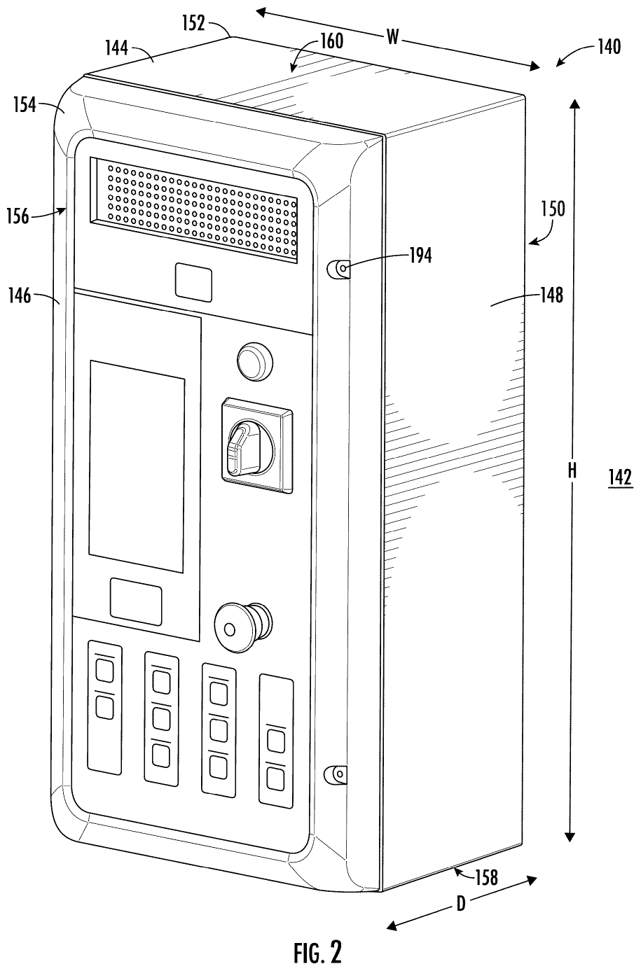

FIG. 2 illustrates a front perspective view of the dock controller 140 in accordance with an example embodiment as seen mounted to the common wall 142. The dock controller 140 comprises a base 144 and a cover 146. The base 144 and cover 146 can be formed from the same type of material using a common manufacturing process, such as injection molding or rotomolding. By way of non-limiting example, the base 144 and cover 146 can be formed from a polymer, such as acrylic (PMMA), acrylonitrile butadiene styrene (ABS), nylon (polyamide), polycarbonate (PC), polyethylene (PE), polypropylene (PP), a thermoplastic elastomer (TPE), a thermoplastic polyurethane (TPU); a metal such as aluminum or stainless steel; a composite, such as carbon fiber; or the like.

The base 144 can include attachment hardware (not illustrated) which allows for attachment of the dock controller 140 to the common wall 142 or a different mount or stand to be located at the loading dock area 100. The attachment hardware can be disposed at one or more sidewalls 148 of the base 144, a rear wall 150 of the base 144, or a combination thereof.

The dock controller 140 defines a height H, a width W, and a depth D all oriented orthogonally with respect to one another. The height H can define a largest dimension of the dock controller 140. The depth D can define a smallest dimension of the dock controller 140. In an embodiment, the height H can be at least 150% the depth D, such as at least 175% the depth D, such as at least 200% the depth D. Use of a relatively large height H and small depth D reduces clearance issues within the loading dock area 100 (FIG. 1) and maximizes spatial efficiency.

In an embodiment, rear apex locations 152 defined by orthogonal junctions between the sidewalls 148 and the rear wall 150 mitigate objects from lodging between the dock controller 140 and the common wall 142. Conversely, front apex locations 154 can define rounded or chamfered corners to mitigate physical harm to loading dock personnel that impact against the dock controller 140.

By way of non-limiting example, the dock controller 140 can define a volume, as delimited by the sidewalls 148, the rear wall 150, and the front wall 156, of at least 0.1 cubic meters (m²), such as at least 0.2 m², such as at least 0.3 m². The volume of the dock controller 140 may be less than 1 m², such as less than 0.7 m², such as less than 0.5 m².

A lower wall 158 of the sidewall 148 may be raised (separated) from a floor of the loading dock area 100 in the mounted position (e.g., when the dock controller 140 is mounted to the common wall 142) by at least 0.5 meters (m), such as by at least 0.75 m, such as by at least 1 m. In a particular embodiment, the lower wall 158 of the sidewall 148 may be raised from the floor of the loading dock area 100 by at least 1.25 m while an upper wall 160 of the sidewall 148 is raised from the floor of the loading dock area 100 by no greater than 2.5 m, such as no greater than 2 m. Within this raised range, the dock controller 140 can avoid impact from passing equipment, such as from forklift arms, without being outside easy access to the average loading dock personnel. The dock controller 140 may include a frangible section (not illustrated) which extends from the lower wall 158 to assist in accurately positioning the dock controller 140 at a desired height. By way of non-limiting example, the frangible section can include an elongated element, optionally including distance markings, that allows the installation technician to position the dock controller 140 at the desired height during installation. The elongated element may be broken off during or after the installation process.

The dock controller 140 may connected to shore power (e.g., a wall outlet at the common wall 142) via an electrical conductor (e.g., an electrical wire) extending through the rear wall 150. In this regard, the dock controller 140 can receive power without requiring exposed cabling that may be impacted and affected by passing loading dock personnel and equipment. In other embodiments, the dock controller 140 may be connected to power through a different attachment site, through a wireless, induction-style charging arrangement, or through an internal battery pack that is periodically charged or replaced.

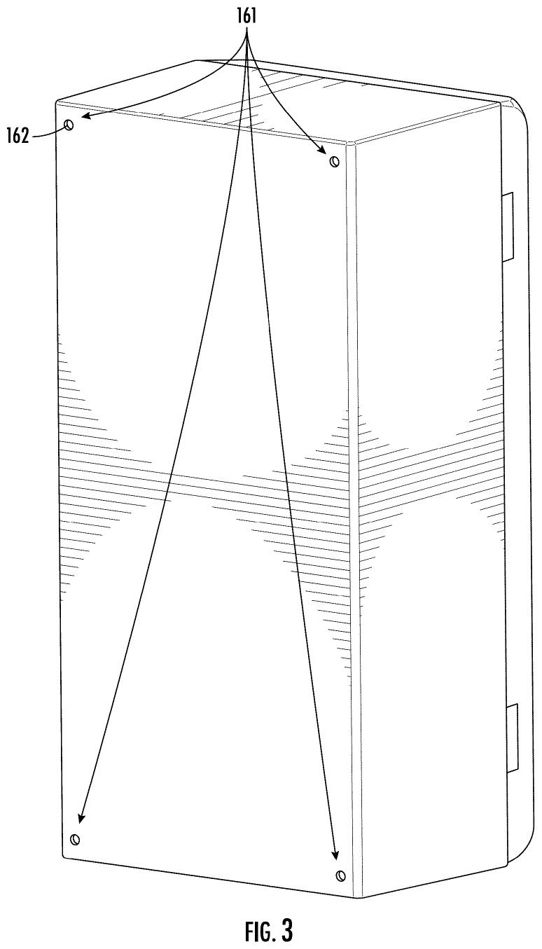

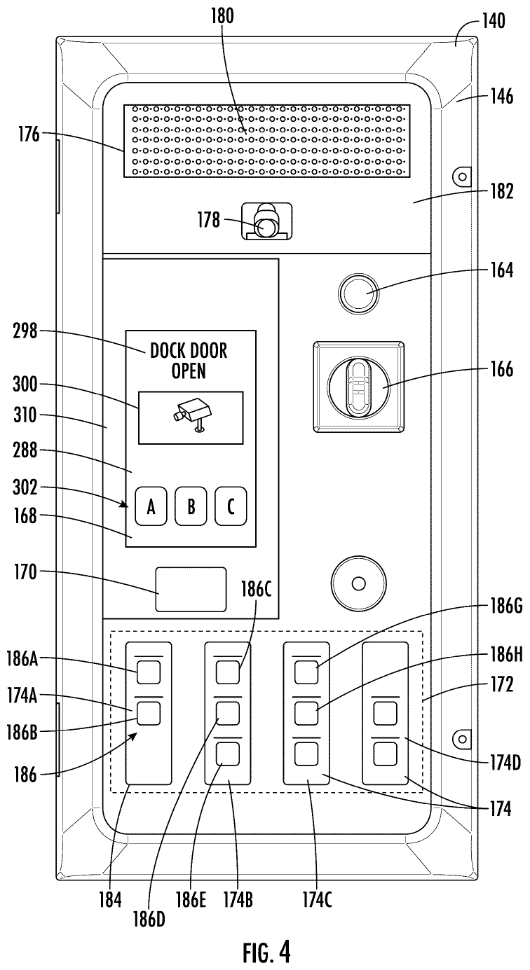

FIGS. 3 and 4 illustrate other external views of the dock controller 140. In particular, FIG. 3 illustrates a rear perspective view of the dock controller 140 and FIG. 4 illustrates a front plan view of the dock controller 140.

Referring initially to FIG. 3, the rear wall 150 of the dock controller 140 can define attachment locations 161 through which the dock controller 140 can be mounted to the common wall 142 or a separate mount. The depicted attachment locations 161 include openings 162 which extend into the rear wall 150. The openings 162 may pass entirely through the base 144 from an exterior of the dock controller 140 to an interior of the dock controller 140. When installing the dock controller 140, e.g., to the common wall 142, the operator may insert a waterproof material into the openings 162 prior to, or while, passing a fastener therethrough. The waterproof material can include, for example, a sealing gel, a caulk, or the like. The waterproof material can mitigate ingress of contaminant (particularly water) into the interior of the dock controller 140 should a leak occur in the building. A basic waterproofing of at least IP4 allows the dock controller 140 to survive leaks. However, it is contemplated that the dock controller 140 might have an IP rating of at least IP5, IP6, IP7, or even IP8.

In an embodiment, the openings 162 may include knockouts (inserts) which close the opening 162 prior to mounting in order to maintain internal components of the dock controller 140 safe during shipping and assembly. The installer can remove the knockouts, e.g., using a screwdriver or hammer, and pass a fastener through the opening 162 and into the common wall 142. In an embodiment, at least one of the knockouts (such as all the knockouts) are replaced by seals formed from a different material than the nearby sidewall. For example, the seals may be formed from a conformal polymer, like rubber. The seals may be inserted into the openings 162 after manufacture of the base 144, formed through an overmolding process, or the like. The seals may deform to accept, and self-seal against, a fastener inserted into the opening 162 to provide a watertight internal volume.

Yet alternatively, the attachment locations 161 may each include a non-pass through mounting feature such that no opening passes through the rear wall 150 into the internal volume of the dock controller 140.

Referring to FIG. 4, the cover 146 of the dock controller 140 may define functional control components which allow loading dock personnel to interact with the dock controller 140 to perform one or more operations at the loading dock 102. The functional control components can include, for example, a power button 164, a safety switch 166, a display 168, a credentialing device (e.g., a near field communication reader 170), and a field 172 including one or more individual user interfaces 174 associated with one or more of the loading dock components described above. The dock controller 140 can also include additional components visible from the exterior of the cover 146, including, for example, an illumination field 176 and a camera 178. Using the functional control components 164, 166, 168, 170, 172, 174 in combination with the additional components 176, 178, the loading dock personnel can effectively control and manage the associated loading dock 102 by generating user inputs through interaction with the functional control components 164, 166, 168, 170, 172, 174, by receiving feedback from one or more of the functional control components, such as the display 168 (and even the illumination field 176), and by monitoring the loading dock area 100 using video feed captured by the camera 178. These components will now be described in greater detail.

To initiate boot up of the dock controller 140, a user can actuate the power button 164. By way of non-limiting example, the power button 164 can include a push-to-power button surrounded by a waterproof skirt or covered by an outer waterproof membrane. The power button 164 can be sprung outward to an extended position. When pressed, the power button 164 can interact with a sensor, such as a potentiometer, which generates a control signal sent to an onboard control unit, e.g., a processor, to initiate the boot up sequence. During the boot up sequence, a system initialization module may be loaded into system RAM and executed. The system initialization module may execute a power on self test (POST) and/or a self integrity check. The system initialization module may then load and execute an authenticator module, a key and signature component, obtain copies of an encrypted boot loader and encrypted OS which are temporarily stored in system RAM, and input them into a verification function. In implementations described herein, the boot up sequence may further include reading statuses of one or more of the loading dock accessories. Status readings may include, for example, loading dock component identification information, determined presence and operability of each connected loading dock component, cycle time, number of active cycles since service, positional data, error data, and the like. These status readings may be stored locally at memory at the dock controller 140. Where one or more status readings associated with one or more loading dock components is outside a threshold or tolerance, the dock controller 140 can generate a flagged status for further review. In some instances, the dock controller 140 may notify a remote computing device, such as a computing device of the onsite manager, of the flagged status for further review. Where the flagged status meets or exceeds a prescribed level or threshold, the dock controller 140 may enter a safe mode whereby full use of the functionality associated with the dock controller 140 is limited. In some implementations, safe mode may entirely restrict use of the dock controller 140. In other implementations, safe mode may limit functionality to only certain activities or control operations. The scope of the limited functionality may correspond to the nature of the flagged status. For example, where the flagged status is minor, safe mode may only serve to minimally limit activities at the dock controller 140, whereas a major flagged status may fully impair use of the dock controller 140.

In some implementations, the remote computing device, such as the onsite management system, may indicate which dock controllers 140 are active, in safe mode, etc. The remote computing device may receive a signal from the dock controller(s) 140 during or after boot up to update the indication of operation.

The power button 164 may also be used to power down the dock controller 140 through a controlled shut-off procedure. In the case of an emergency, an operator can quickly shut down the dock controller 140 or affect safe mode operation by activating the safety switch 166. In an embodiment, the safety switch 166 includes a rotatable dial with an elongated projection forming an interface for user engagement therewith. The safety switch is brightly colored to illicit easy visibility in low light environments. By activating the safety switch 166, the dock controller 140 is prevented from performing its full scope of functional operations. For example, in some implementations, activation of the safety switch 166 may cause the dock controller 140 to stop (i.e., freeze) actions being performed by one or more of the loading dock components. In some instances, one or more of the loading dock components is immediately caused to stop upon activation of the safety switch 166. For example, if the dock leveler 112 is actively moving from a raised position to a lowered position, activation of the safety switch 166 can stop further movement of the dock leveler 112, causing the dock leveler 112 to remain in its current position. In other instances, one or more of the loading dock components is caused to enter a safe mode in response to activation of the safety switch 166. For example, instead of remaining in its current position, the dock leveler 112 may immediately begin to move towards a prescribed position, such as a vertically raised position. The dock leveler 112 may receive instruction from the dock controller 140 to complete the further movement in safe mode, for example, travelling at reduced speed and/or with greater sensitivity for environmental impact (e.g., a dangerous condition). The safety switch 166 may be reset after completion of the unsafe condition that caused activation.

In some implementations, overriding the resulting safe mode may be performed by an onsite manager. For example, the near field communication reader 170 may be configured to read information from a badge or other credential. The onsite manager may scan their credential at the near field communication reader 170 to initiate an override or reset procedure that restores normal working order of the dock controller 140. Using the display 168, for example, the onsite manager can navigate through the override or reset procedure to exit safe mode. The display 168, however, may remain locked until such time that an authorized credential is received at the near field communication reader 170.

The illumination field 176 may provide visual information to nearby loading dock personnel. The illumination field 176 can include a light panel 180 disposed within the interior of the dock controller 140. The light panel 180 may include, for example, a field of light emitting diodes (LEDs), that are individually and/or collectively switchable between two or more illumination statuses (e.g., on, off, brightness level, flashing v. solid, color, etc.). The light panel 180 may be covered by a transparent, or semi-transparent, portion of the cover 146, such as a screen 182 that extends over the light panel 180.

The illumination field 176 may extend across at least 50% of the width W (FIG. 2) of the dock controller 140, such as at least 75% of the width W. The illumination field 176 can define a large visual portion of the cover 146 (such as at least 5% of the areal size of the cover 146) to provide nearby loading dock personnel with easy-to-see information associated with the status of the loading dock 102, the status of the dock controller 140, and/or the status one or more individual loading dock components.

In addition to covering the light panel 180, the single-piece screen 182 may also cover the camera 178, or more particularly the opening through which the camera 178 can view a location in front of the cover 146. The screen 182 may be coupled to the cover 146 in a watertight manner, such as via a watertight adhesive, or otherwise sealed to mitigate ingress of contaminant (e.g., water) into the interior of the dock controller 140 through openings associated with the light panel 180 and camera 178. The screen 182 may be transparent, or semi-transparent, to permit the camera 178 to capture image data therethrough.

The screen 182 may be disposed at an upper end of the dock controller 140 to provide the camera 178 with a better visual field of view and to provide the illumination field 176 with a greater impact on nearby loading dock personnel. That is, higher placement may provide a visual vantage point overlooking loading dock component (like forklifts), pallets and freight being loaded onto and offloaded from the vehicle 138 (FIG. 1), and the like. The field 172 of individual user interface(s) 174 associated with one or more of the loading dock components described above may be disposed on a lower end of the dock controller 140 opposite the screen 182 for easy, reachable access to loading dock personnel.

The field 172 may define a plurality of regions 184 each configured to receive one of the user interfaces 174. The regions 184 may each be defined by a recessed portion of the cover 146 in which a respective one of the user interfaces 174 can be coupled. Each of the user interfaces 174 may be associated with a different one of the loading dock components. For example, a first user interface 174A may be associated with the vehicle restraint 114, a second user interface 174B may be associated with the movable barrier operator 106, a third user interface 174C may be associated with the dock leveler 112, and a fourth user interface 174D may be associated with other auxiliary loading dock component, such as a dock light or dock fan. The field 172 may define a greater or fewer number of regions 184 housing more or less user interfaces 174. Moreover, the above user interfaces are merely examples and are not intended as limiting. Other user interfaces may be implemented to control other aspects of the loading dock area 100.

The user interfaces 174 may all share a common shape, size, or both. The user interfaces 174 may be equidistantly spaced apart from one another and all oriented in a common direction. In the depicted embodiment, the user interfaces 174 are all vertically elongated and stacked in the horizontal direction.

At least one of the user interfaces 174 can include at least one user control, such as a button 186, which permits a user to control one or more operations at the loading dock 102 from the dock controller 140. For example, where the first user interface 174A is associated with the vehicle restraint 114, the first user interface 174A can include a first button 186A entitled “Restraint Engage” and a second button 186B entitled “Restraint Release”. When the first button 186A is acted upon, e.g., depressed, the vehicle restraint 114 is caused to engage with the vehicle 138 (FIG. 1). Conversely, when the second button 186B is acted upon, e.g., depressed, the vehicle restraint 114 is caused to release (disengage) from the vehicle 138.

The buttons 186 can be chronologically arranged based on an order of operations to be performed at the dock controller 140. That is, for example, the vehicle restraint 114 must be engaged before release (disengagement) is possible. Thus, the first button 186A entitled “Restraint Engage” is disposed above the second button 186B entitled “Restraint Release”. Similarly, the user interfaces 174 themselves can be chronologically arranged based on the order of operations to be performed at the dock controller 140. That is, for example, the first user interface 174A (i.e., the leftmost of the user interfaces 174) may be associated with the vehicle restraint 114 and the second user interface 174B (i.e., the user interface 174 directly to the right of the first user interface 174A) may be associated with the movable barrier operator 106. The second user interface 174B can include a first button 186C entitled “Door Open”, a second button 186D entitled “Door Close”, and a third button 186E entitled “Door Stop”. In the typical order of operations, the vehicle restraint 114 (as controlled by the first (leftmost) user interface 174A) is activated first using the first button 186A and, only after successful restraint of the vehicle is achieved, the movable barrier 104 (FIG. 1) is opened by engaging the first button 186C of the second user interface 174B. Similarly, the third user interface 174C may be associated with the dock leveler 112 and arranged immediately to the right of the second user interface 174B. Activation of the dock leveler 112 is only performed after the movable barrier 104 is opened. The third user interface 174C may include a first button 186F entitled “Leveler Raise”, a second button 186G entitled “Leveler Lower”, and a third button 186H entitled “Leveler Lip”. In this implementation, the dock leveler 112 is initially raised using the first button 186F after the movable barrier 104 is in the open position. If the dock leveler 112 is raised too far, the loading dock personnel operating the dock controller 140 can activate the second button 186G to lower the dock leveler 112. For vertically-stored dock levelers 112, the first and second buttons 186F, 186G may be inverted such that lowering is chronologically performed first. It is thus clear that the buttons 186 may be chronologically arranged in a manner conducive to the typical order of operations to be performed at the dock controller 140. In a particular embodiment, the chronological arrangement can be left-to-right for each of the individual user interfaces 174 and top-to-bottom for each of the individual buttons 186. Other example chronological arrangements include right-to-left for each of the individual user interfaces 174, bottom-to-top for each of the buttons 186, middle-out for either the user interfaces 174 and/or the buttons 186, outward-to-inward for either the user interfaces 174 and/or the buttons 186, location determinant (e.g., the relative location of the individual loading dock components relative to one another dictate location of the associated user interface 174), or the like. In an embodiment, the user interfaces 174 may be vertically stacked instead of horizontally stacked. Where the user interfaces 174 are vertically stacked (or arranged in any other pattern or relative placement), the chronological arrangement of the user interfaces 174 and/or the buttons 186 may be affected using one of the chronological arrangements described above in view of the spatial arrangement of the user interfaces 174.

The dock controller 140 may be in the form of a modifiable kit that allows for customization and upgrades over time. For example, some loading dock owners may not initially require control over certain loading dock components, like dock levelers 112 (e.g., the loading dock area 100 is devoid of dock levelers 112). These owners may obtain the dock controller 140 with fewer than all four user interfaces 174A, 174B, 174C, 174D based on their current need. After some time, the owner may install dock levelers at one or more loading docks 102. At that time, the dock controller 140 can be upgraded to include the additional user interface 174C associated with the dock leveler 112. Prior to adding the additional user interface 174C, the third region 184 of the field 172 may be left blank, i.e., without one of the user interfaces 174. In some implementations, a blank insert (not illustrated) may be received at the third region 184 (or any other region 184) when no user interface 174 is present at that spot. The blank insert may have a shape corresponding to the user interface 174. However, the blank insert does not include buttons 186. The blank insert can fill the region 184 to mitigate ingress of debris into the interior of the dock controller 140 and increase aesthetic of the dock controller 140.

To swap between the blank insert and one of the user interfaces 174, or to perform a circuitry-related aspect of maintenance or service, the front cover 146 is moved from the closed position (FIGS. 2 to 4) to an open position.

FIG. 5 is a front perspective view of the dock controller 140 as seen with the cover 146 in the open position in accordance with an example embodiment. To open the dock controller 140, the cover 146 is pivoted about an axis 188 defined by one or more hinges 190 interfacing between the base 144 and the cover 146. The axis 188 can extend in a generally vertical direction when the dock controller 140 is mounted within the loading dock area 100. The cover 146 can pivot about the axis 188 laterally in opposite directions associated with line 192. Referring again to FIG. 2, the cover 146 can be locked in the closed position, such as by one or more threaded fasteners 194 extending through the cover 146 and anchoring within threaded openings 196 (FIG. 5) in the base 144. Alternatively, or in addition, the cover 146 can be locked in the closed position another type of locking mechanism, such as a pin tumbler lock, a magnetic lock, an electronic lock, or the like.

The base 144 defines an interior volume 198 having an open front 200 defined by the sidewalls 148. The base 144 may include a multi-plenum construction with a secondary volume 202 disposed between the sidewalls 148 and the interior volume 198. In some instances, the secondary volume 202 may extend fully around the interior volume 198. The secondary volume 202 may act as a sealing buffer to mitigate water ingress, a temperature buffer to reduce thermal transfer between the interior volume 198 and the external environment, or the like.

Circuitry of the dock controller 140 can be split between the base 144 and the cover 146. For example, a first set of circuitry 204 may be attached to the cover 146 and a second set of circuitry 206 may be attached to the base 144. The first set of circuitry 204 may travel with the cover 146 when the cover 146 is moved between the open and closed positions. The second set of circuitry 206 may remain at a relatively fixed location while the cover 146 moves.

Referring initially to the second set of circuitry 206, the base 144 may house electrical hardware such as a transformer 208 coupled to a power cord 210 to receive shore power, circuit breakers 212, electrical junctions 214, and one or more printed circuit boards (PCBs) 216 electrically coupling processors and memory storage devices. In an embodiment, the PCBs 216 can be elevated from the rear wall 150 by one or more spacers 218.

The electrical junctions 214 may be configured to interface with one or more of the loading dock components described herein to provide user control of the loading dock component(s) at the dock controller 140. The electrical junctions 214 may include, for example, connector ports that receive one or more electrical conductors from the loading dock component(s), facilitating the transmission of electrical signals between the loading dock component(s) and the dock controller 140. The connector ports may include a threaded or snap fit fastener that retains the electrical conductors fixed at the electrical junctions 214 to enable bidirectional or unidirectional communication for power and/or control functionality from the dock controller 140. The connector ports may be sized and/or shaped to accommodate various wire types, ensuring compatibility with a wide range of loading dock components. The wires may exit the dock controller 140 and run to the separate loading dock components.

In some installations, a splice can be formed from an existing wire or wiring harness of the loading dock component and run to the dock controller 140. In other installations, the existing wire or wiring harness may be rerun directly to the dock controller 140. In yet other installations, the existing wire or wiring harness may be removed and/or replaced by a new wiring scheme to connect the loading dock component to the dock controller 140. The rewiring installation can be performed during initial installation, at a later time during an onsite retrofit, or a combination of both.

Alternatively, or in addition, the dock controller 140 may be configured to wirelessly communicate with at least one of the loading dock components through a wireless communication interface (e.g., Zigbee wireless technology, Wi-Fi, Bluetooth, etc.). For example, the wireless communication interface can establish communications over one or more wireless communication channels (e.g., via local area networks, wide area networks, the Internet, cellular networks, mesh networks, etc.). The one or more channels can include one or more encrypted and/or unencrypted channels. The channels, for instance, can include gRPC messaging. For instance, in some implementations, the channels can include unencrypted channels, encrypted using one or more cryptographic signing techniques (e.g., symmetric signing, asymmetric signing, etc.). The dock controller 140 may pair with the loading dock component, for example, by broadcasting a beacon signal and awaiting response from available loading dock components.

In some implementations, the dock controller 140 can further include a battery backup (not illustrated) which powers the dock controller 140 when shore power is lost. In some instances, the battery backup may be capable of powering one or more loading dock components in addition to providing onboard power for the dock controller 140. For example, the battery backup may be configured to provide power to the camera(s) 116, 118 (FIG. 1), the notification system 132 (FIG. 1), the photo beam system 108 (FIG. 1), or the like. The battery backup may be configured to allow a certain number of operations at the loading dock prior to exhausting power. For example, the battery backup may be sufficiently sized to power each of the loading dock components through one phase of motion. In this regard, the battery backup can be used to move the dock leveler out of the way of the movable barrier, to close the movable barrier, and to release the vehicle restraint. The battery backup may be part of the second set of circuitry 206 disposed in the base 144 to minimize weight on the cover 146 in the open position.

The first set of circuitry 204 may include circuitry components and hardware associated with the various functional components coupled to the cover 146. For example, the cover 146 can support the illumination field 176, the camera 178, the display 168, the near field communication reader 170, and the field 172 of user interfaces 174 (FIG. 2).

Starting from the top (though not limited to the following exemplary spatial layout), the illumination field 176 can include a flat light board panel with a plurality of integrated light emitting diodes (LEDs) arranged in rows and columns, equidistantly spaced apart. The LEDs are coupled to power and receive control instructions from onboard processors to change the perceived brightness, color, and animation (e.g., flashing, solid, etc.) of the illumination field 176. The illumination field 176 may be caused to display a green color during normal operations of the dock controller 140, a red color during atypical operations, an orange color during servicing and repair operations, or any other color for any other desired notification purpose. In some instances, the individual LEDs may be controlled to generate alphanumeric symbols, such as for a countdown timer or the like. The flat light board panel may be secured to an inside surface 220 of the cover 146, e.g., by a plurality of threaded fasteners. Side gaps between the flat light board panel and the inside surface 220 may be sealed or bounded to mitigate light from passing between the interior volume 198 and the screen 182 (FIG. 4) to reduce glare and edge distortion.

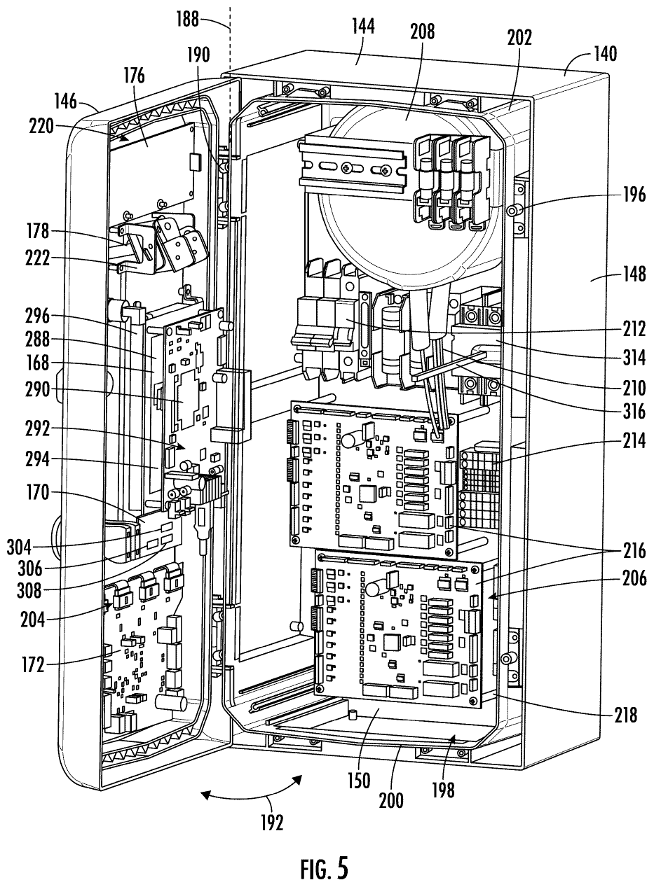

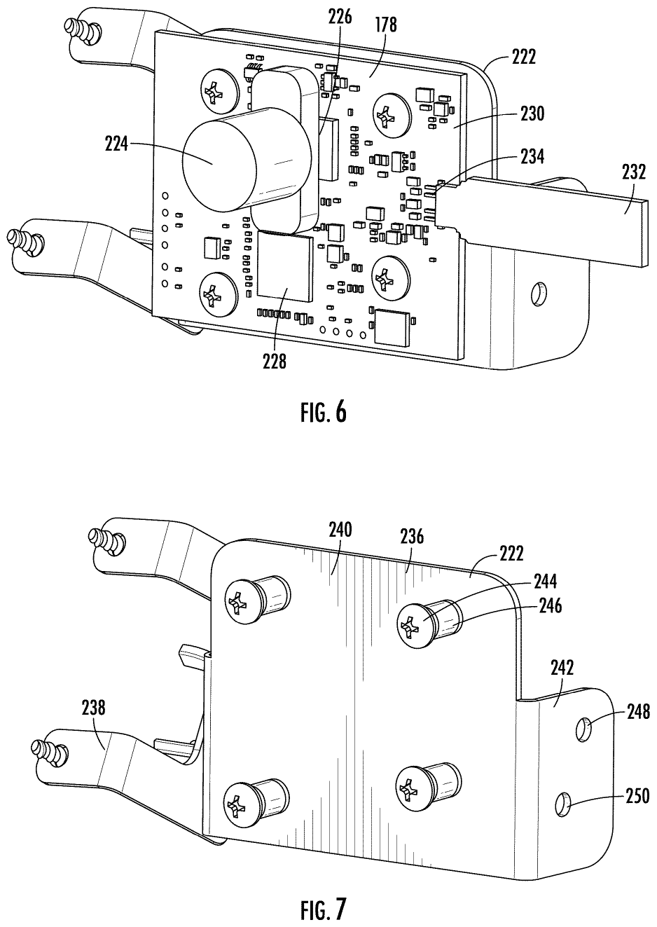

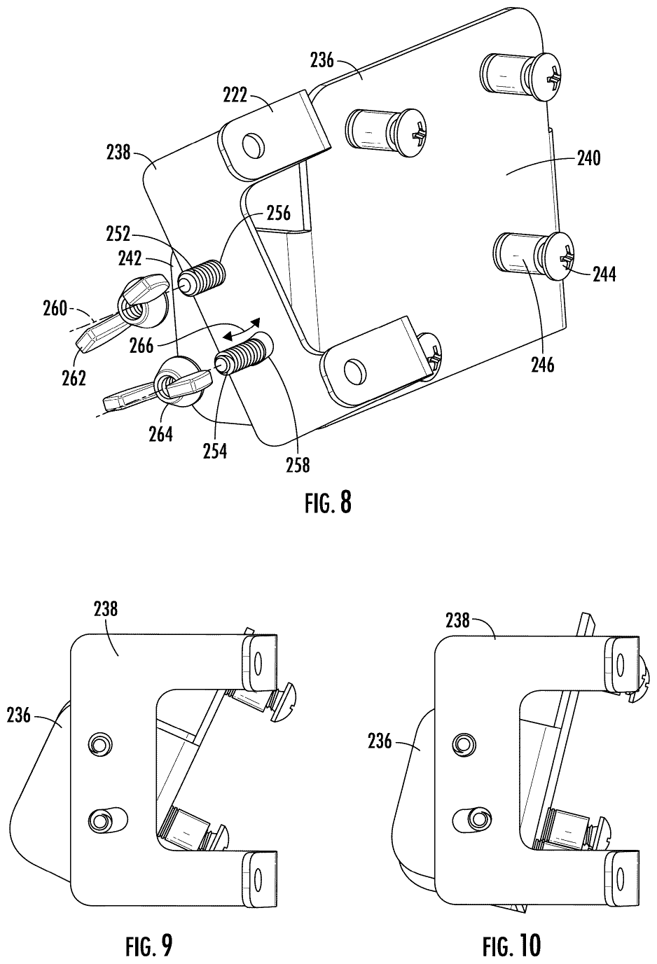

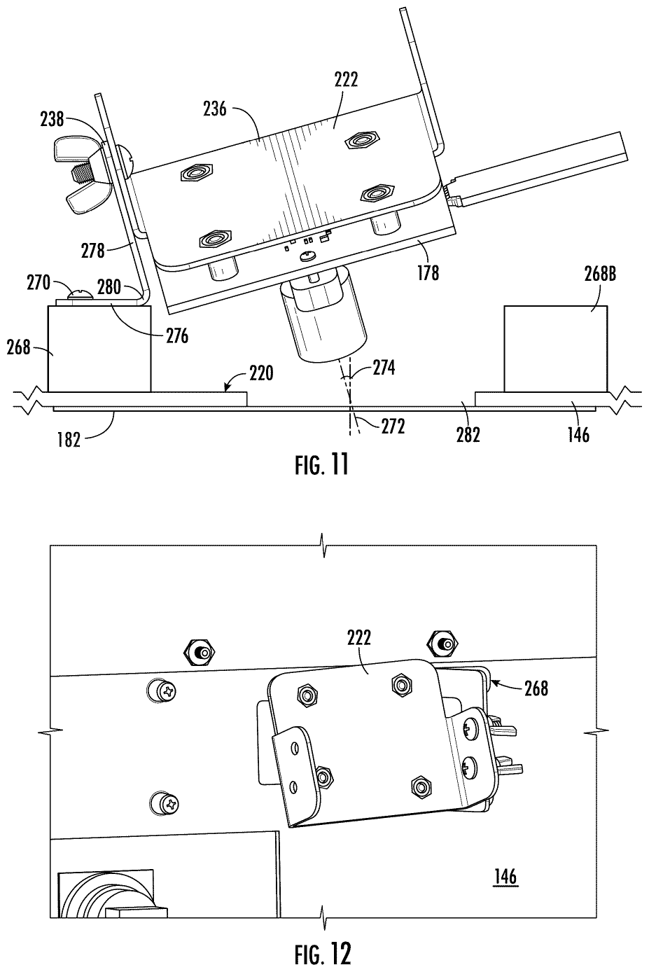

The camera 178 is mounted to the cover 146 via a bracket 222. The bracket 222 permits adjustable positioning of the camera 178 to customize the camera field of view orientation relative to the loading dock area 100 (FIG. 1). FIGS. 6 to 13 illustrate aspects of the camera 178 and bracket 222 in accordance with an example embodiment. In particular, FIG. 6 illustrates a front, right perspective view of the camera 178 and bracket 222, FIG. 7 illustrates a front, right perspective view of the bracket 222 as seen with the camera 178 removed, FIG. 8 illustrates a front, left perspective view of the bracket 222 as seen with the camera 178 removed, FIG. 9 illustrates a side view of the bracket 222 in a first setup, FIG. 10 illustrates the same side view of the bracket 222 in a second setup different from the first setup, FIG. 11 is a top view of the bracket and camera, FIG. 12 illustrates a perspective view of the bracket 222 mounted to the inside surface 220 of the cover 146 in a first mounting orientation, and FIG. 13 illustrates a perspective view of the bracket 222 mounted to the inside surface 220 of the cover 146 in a second mounting orientation different from the first mounting orientation.

Referring initially to FIG. 6, the camera 178 includes a lens 224 which focuses light received from the nearby environment. The lens 224 may include a fixed or adjustable aperture, and optionally, a focus mechanism (e.g., an autofocus mechanism). The lens 224 can supply received light to an image sensor 226 which converts the received light into electrical signals for digital processing. The image sensor 226 can include a complementary metal-oxide semiconductor (CMOS) sensor, photodiodes, and/or a Bayer filter. An image processor 228 receives electrical signals from the image sensor 226 and handles conversion of raw data contained in the electrical signals to a final image file. In some implementations, the image processor 228 can apply noise reduction, color correction, and/or other processing techniques to modify and adjust the final image file. One or more of the lens 224, the image sensor 226, or the image processor 228 can be coupled to a main circuit board 230 (sometimes referred to as a motherboard). Power is supplied to the various components of the main circuit board 230, e.g., from the transformer 208 (FIG. 5). In some implementations, a memory 232 (e.g., a secure digital (SD) or micro-SD card) is coupled to the camera 178, such as through a pinned connection 234. The memory 232 can store data from the camera 178, such as final image files and/or the raw data used to derive the final image files. The memory 232 can have at least 2 gigabytes (GB) of capacity, such as at least 128 GB of capacity, such as at least 1 terabyte (TB) of capacity, such as at least 16 TB of capacity. In some implementations, the memory 232 is removable from the dock controller 140. In other implementations, the memory 232 is integral with the camera 178 and not readily removed from the dock controller 140. In yet other implementations, the memory 232 can be split between a removable portion and a fixed (local) portion. The memory 232 may be expandable. For example, the pinned connection 234 may allow for ganging of multiple memory cards, such as at least two memory cards, at lease three memory cards, etc.

The camera 178 can capture images at framerates of at least 1 frame per second (FPS), such as at least 10 FPS, such as at least 30 FPS and store the image(s) on the memory 232. Stored data can be overwritten using circular (ring) buffering, and more particularly first in, first out (FIFO) circular buffering in view of memory capacity. The memory 232 can store at least 8 hours of video at a framerate of at least 10 FPS. In an embodiment, the memory 232 can store at least 144 hours of video at a framerate of 30 FPS. Settings associated with buffering and other attributes of the memory 232 and/or camera 178 may be controlled at the dock controller 140 itself, such as for example, by interacting with the display 168.

Referring to FIGS. 7 and 8, the bracket 222 includes a first portion 236 and a second portion 238 coupled to the first portion 236. The first portion 236 can include a generally planar receiving area 240 where the camera 178 is mounted, and one or more flanges 242 extending from the generally planar receiving area 240. The camera 178 can be fixedly coupled to the first portion 236, e.g., using one or more threaded fasteners 244 that threadably interface with bosses 246 of the first portion 236. The main circuit board 230 of the camera 178 can be spaced apart from the generally planar receiving area 240 by a dimension corresponding to a length of the bosses 246 to permit airflow to cool the main circuit board 230 and associated components of the camera 178.

The first portion 236 of the bracket 222 may be adjustably coupled to the second portion 238. For example, the flange(s) 242 can each define a plurality of openings 248, 250. The first opening 248 can receive a pivot 252 and the second opening 250 can receive a threaded fastener 254. In an embodiment, the pivot 252 and threaded fastener 254 are fungible and both define a threaded interface. The second portion 238 of the bracket 222 can include an opening 256 through which the pivot 252 extends and a slot 258 through which the threaded fastener 254 extends. The slot 258 can define a curvature with a central radius location at the axis 260. The first and second portions 236, 238 can rotate relative to one another about an axis 260 formed by the pivot 252. As the first and second portions 236, 238 rotate relative to one another, the threaded fastener 254 moves relative to the slot 258. A locking component 262, 264, such as a wingnut, can be coupled to each of the pivot 252 and the threaded fastener 254 and tightened to selectively retain the first and second portions 236 at a fixed relative position. Maximum total displacement between the first and second portions 236, 238 may be defined by an arc length of the slot 258. In an embodiment, the arc length of the slot 258 can permit at least 5° of displacement, such as at least 10° of displacement, such as at least 15°, such as at least 20° of displacement in direction 266.

FIGS. 9 and 10 illustrate the bracket 222 at end ranges of travel, as adjusted by relative movement between the first and second portions 236, 238. In particular, FIG. 9 illustrates the second portion 238 in a downward-most orientation and FIG. 10 illustrates the second portion 238 in an upward-most orientation. The camera 178 can have a horizontal field of view (HFOV) of at least 90°, such as at least 120°, such as at least 140° and a vertical field of view (VFOV) of at least 90°, such as at least 120°, such as at least 140°. Adjustments to the angle of the first portion 236 relative to the second portion 238 can thus allow the camera 178 to be oriented based on environmental considerations at the loading dock area 100. Where field of view immediately below the dock controller 140 is desired, the first portion 236 may be adjusted to the downward-most orientation as depicted in FIG. 9. Conversely, where field of view immediately below the dock controller 140 is not necessary, the first portion 236 may be adjusted to the upward-most orientation (or a relative position therebetween) to capture higher aspects of the environment.

FIG. 11 illustrates a top view of the bracket 222 and camera 178 as seen with the first and second portions 236, 238 disposed at a particular relative orientation. As depicted, the second portion 238 can be coupled to the cover 146 through a mounting platform 268 which may be integral with, or separate from, the cover 146, using a fastener 270.

The bracket 222 may be shaped to laterally cant the camera's field of view towards a lateral side. A central axis of the camera's field of view is depicted by line 272. The central axis of the field of view may be angularly offset from centered relative to the front of the cover 146 by a canting angle 274 of at least 2°, such as at least 5°, such as at least 10°. Referring again to FIG. 1, each dock controller 140 may be associated with a laterally adjacent loading dock 102. The camera 178 may be canted by the canting angle 274 towards the associated loading dock 102 to effectively capture the associated loading dock 102 with greater clarity and with a larger portion of the field of view. In the depicted embodiment, the camera 178 is canted towards the right side of the page and thus would capture a greater portion of the loading dock disposed at the right side.

By way of non-limiting embodiment, the canting angle 274 may be achieved at the second portion 238 of the bracket 222. For example, the second portion 238 can include a first segment 276 and a second segment 278 interfacing at a junction 280. In an embodiment, the first and second segments 276, 278 can be formed from a single-piece construction, such as from a single piece of sheet metal, such that the junction 280 is formed by bending the single piece to form a non-orthogonal relationship between the first and second segments 276, 278. The bent angle of the junction 280 can dictate the canting angle 274 of the field of view of the camera 178. In certain instances, the second portion 238 can be deformed, e.g., at the junction 280, to modify and customize the canting angle 274 for a particular loading dock area 100. The second portion 238 can plasticly deform during the customizing deformation process to retain the customized canting angle 274 for future image capture.

Referring again to FIG. 1, the individual dock controllers 140 may be mounted to the left or right sides of the associated loading docks 102. The preferred mounting side may vary based on spatial limitations of the common wall 142, particularly at lateral ends thereof. For example, it is not atypical for one of the lateral-most loading docks 102 to be disposed immediately next to a wall, a support pillar, a building mechanical (like HVAC or wiring), etc. To accommodate such arrangements, the dock controller 140 is installed on the opposite side of the loading dock 102. Where the gap between adjacent loading docks 102 is not sufficiently large to accommodate multiple dock controllers 140 between two loading docks 102, the rest of the loading docks 102 are all arranged based on the selected side of the compromised end loading dock 102. Thus, the dock controller 140 is configurable between both lefthand and righthand mounting locations to accommodate a wider range of use cases.

Referring again to FIG. 11, the bracket 222 may be configured for adjustable mounting between lefthand and righthand orientations by inverting the bracket 222 and switching the mounting point from the aforementioned mounting platform 268 to a second mounting platform 268B disposed on an opposite side of the camera opening 282. FIGS. 12 and 13 depict the mounting bracket 222 arranged in inverted mounting positions. In particular, FIG. 12 depicts a first orientation where the bracket 222 is coupled to the mounting platform 268 to orient the camera 178 in a first direction and FIG. 13 depicts a second orientation where the bracket 222 is coupled to the second mounting platform 268B to orient the camera 178 in a second direction different from the first direction.

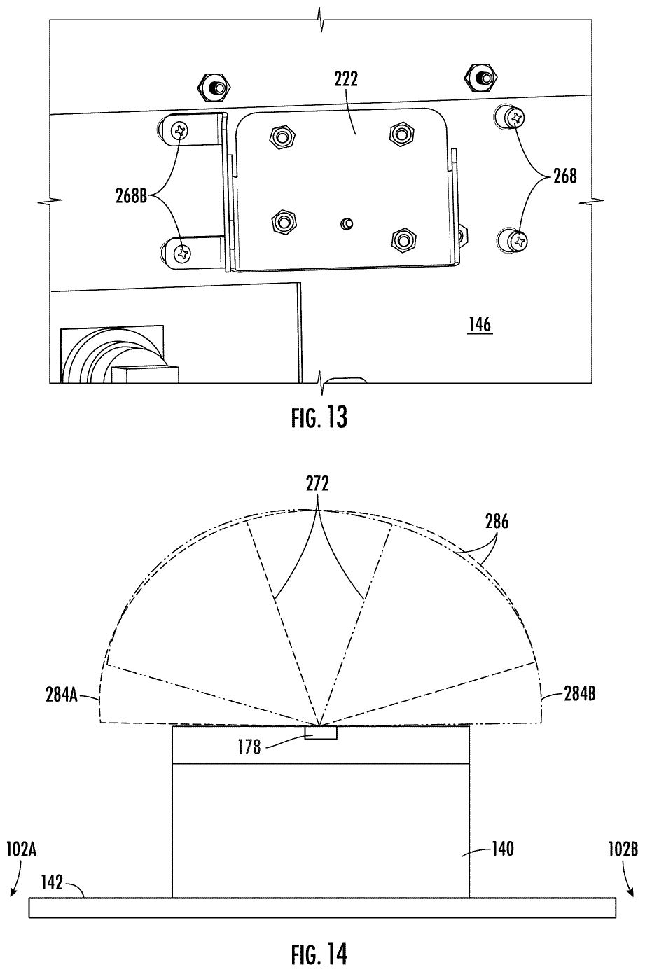

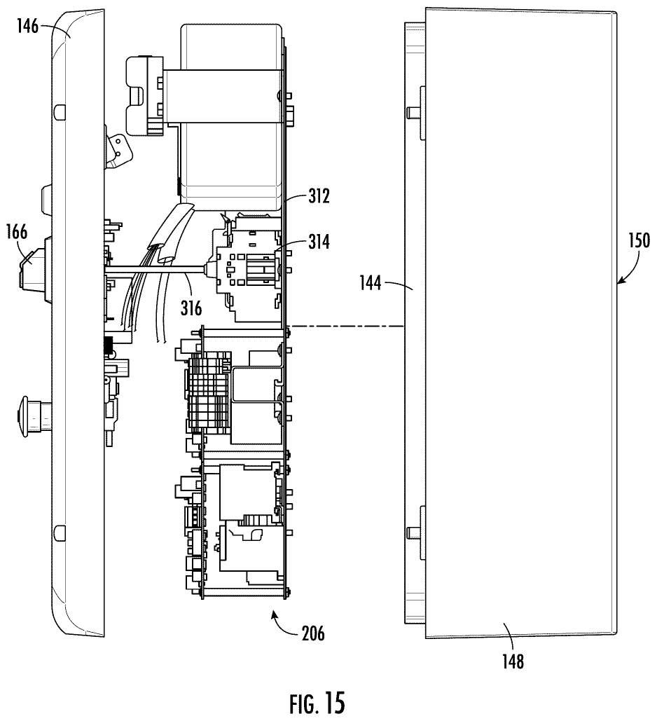

FIG. 14 illustrates a top plan view of the dock controller 140 depicting overlapping fields of view associated with a lefthand mounted camera 284A and righthand mounted camera 184B. As depicted, the field of view for the lefthand mounted camera 284A captures a greater area associated with the first loading dock 102A. Conversely, the field of view for the righthand mounted camera 284B captures a greater area associated with the second loading dock 102B. The additional captured fields of view may correspond to the relative canting angle 274 associated with the central axis 272 of the respective mounting orientation. While FIG. 14 depicts far field termination boundaries 286 for each of the fields of view, the relative distance from the camera 178 to the boundary 286 is not shown drawn to scale.

Referring again to FIG. 5, the display 168 can be disposed below the camera 178. The display 168 can include a screen 288 (FIG. 4), such as a liquid crystal display (LCD), an LED display, an organic LED (OLED) display, an active matrix organic light emitting diode (AMOLED) display, a quantum dot LED (QLED), a plasma display, an electrophoretic ink (E Ink) display, an In-Plane Switching (IPS) display, a twisted nematic (TN) display, a microLED, a laser display, or the like. The display 168 can include a graphics processing unit (GPU) 290 that receives instructions, e.g., from an onboard processor, and generates graphical content to be displayed on the screen 288, including images, video, text, and (optionally) interface elements that can selected by a loading dock personnel. The GPU 290 can communicate instructions to display driver circuitry 292 that controls individual pixels of the screen 288. For screens 288 requiring pixel illumination, the display 168 can further include a backlight 294. Additionally, for screens 288 with touch capacity, the display 168 can include a touch interface that receives user gestures, e.g., via capacitive or resistive pressure, and sends touch input data to an onboard processor. The display 168 can be coupled to the cover 146 via a framework 296.

Referring to FIG. 4, the screen 288 can be configured to display text 298, image(s) and/or video 300, and/or icons 302 that are selectable through a user gesture. The screen 288 can provide status information associated with operation of the dock controller 140 and/or loading dock components in communication with the dock controller 140 (e.g., whether the vehicle restraint is engaged, whether the movable barrier is open or closed, a position of the dock leveler, etc.), status information associated with an exterior environment (e.g., whether a vehicle is present at the loading dock, etc.), status information associated with a state of a vehicle at the loading dock (e.g., is freight present in the vehicle trailer, how much freight is present, vehicle identifying information, vehicle driver information, etc.), status information associated with loading dock personnel (e.g., a count showing how many loading dock personnel or equipment are expected to be present at the loading dock based on a work operation being performed), status information associated with the work operation (e.g., load/unload time, remaining time, etc.), or the like. The screen 288 can provide an area for the loading dock personnel to interact with the dock controller 140, such as for example via icons 302. While three rounded-rectangles are shown as example icons 302, it should be understood that yet other types of icons 302 may populate the screen 288. For example, icons 302 can include interactable sliders which the loading dock personnel can drag across the screen 288, shaped images which quickly identify an aspect of their purpose (e.g., a truck trailer icon associated with presence verification to be pressed by loading dock personnel to confirm vehicle presence at the loading dock), or the like. In some implementations, the screen 288 may display any combination of text 298, image(s) and/or video 300, and icons 302 to guide the loading dock personnel through a work operation. For example, the screen 288 may provide information for interacting with the user interfaces 174. When a vehicle arrives at the loading dock, the screen 288 can initially provide indication of vehicle arrival, e.g., with text entitled “Vehicle Arrival at Loading Dock XX”. In some implementations, the screen 288 can also display video from the exterior camera 116.

The screen 288 can then display information associated with an initial step of preparing the vehicle for an upcoming work operation (like unloading/loading of the vehicle trailer). Where the initial step is engagement of the vehicle restraint 114 (FIG. 1), the screen 288 may display information to initiate loading dock personnel to use the first user interface 174A. The screen 288 may also display information for interacting with the user interface 174, such as which button 186 to press. The screen 288 may update as the loading dock personnel interacts with the dock controller 140. For instance, the screen 288 may depict a video of the vehicle restraint 114 interacting with the vehicle. The video may include a live video feed from outside the building and/or a graphical representation or animation of the vehicle restraint 114 interacting with the vehicle. The depicted video may occur in real time, allowing the loading dock personnel to see the status of the vehicle restraint 114 (or another loading dock component) in real time. The screen 288 can also, or alternatively, display other information relating to camera feed captured by the exterior camera 116, such as for example, a type of vehicle restraint engaged or to be engaged with the vehicle. Some loading docks include multiple different types of vehicle restraints 114, such as hooks for engaging RIG bars, wheel chocks for impeding wheel movement, side clamps for clamping against a side body of the trailer, etc. Camera feed from the exterior camera 116 allows loading dock personnel to evaluate which, if any, of the vehicle restraints 114 are actively engaged with the vehicle. In some implementations, the camera screen 288 can provide text or image(s) that allow the loading dock personnel to quickly evaluate the activated vehicle restraint. For example, the screen 288 can display a message (such as, e.g., “RIG bar engaged”), an icon showing the wheel chock in place, a count of a number of activated (engaged) vehicle restraints 114, or the like. The dock controller 140 may generate the text and/or image data using a vision processor, a machine learning process, a large language model (LLM), or the like.

In some instances, the screen 288 can include a countdown until completion of an active step, such as a filling progress bar or progress circle, a time-lapse clock, a numerical countdown animation, a filling shape, and/or a bar chart. In this regard, the loading dock personnel can monitor the relative progress of the active step. Once the active step completes, the screen 288 can then display further information for completing a next step, such as opening the movable barrier 104 (FIG. 1) using the second user interface 174B. This process can repeat for each of the various steps necessary to prepare the loading dock 102 for the intended work operation.

In some instances, one or more of the user interfaces 174 can provide a visual indication that complements (i.e., corresponds with) information displayed on the screen 288. For example, where the screen 288 displays information associated with use of the vehicle restraint 114 (FIG. 1), the corresponding first user interface 174A, or a portion thereof, may become illuminated, such as for example via a backlight described in greater detail below. The dock controller 140 can thus generate easy-to-follow instructions every time an action is taken at the loading dock. As a result, less training is required for loading dock personnel prior to interacting with the dock controller 140.

The near field communication reader 170 is configured to wirelessly transmit and receive information within a short distance, up to 100 millimeters (mm), using electromagnetic induction. Referring again to FIG. 5, the near field communication reader 170 can include an antenna 304, a transmitter 306, and a receiver 308. The antenna 304 can generate an alternating magnetic field that powers and communicates with near field communication enabled devices, such as smart cards, mobile phones, or the like. These enabled devices are equipped with near field communication tags that communicate with the transmitter 306 and receiver 308. The near field communication reader 170 can be optimized for security and ease of use to ensure that a data exchange rate is fast, reliable, and resistant to unauthorized access or interference.

As previously described, the near field communication reader 170 can allow the dock controller 140 to identify authorization credentials, such as for example, during an emergency. In some instances, the near field communication reader 170 can be used to badge in loading dock personnel to a loading dock. For instance, each loading dock personnel may be required to scan their badge at the near field communication reader 170 to confirm authorized presence. In some instances, the screen 288 may display the names of loading dock personnel expected at the loading dock for a particular work operation. The displayed names can be removed or changed upon successful authorization. The dock controller 140 may be configured to restrict use of one or more loading dock components prior to authorizing all expected loading dock personnel, a critical number of loading dock personnel, or a designated team leader. In an embodiment, badging in at the near field communication reader 170 can be replaced or supplemented by facial recognition using video feed, e.g., generated by the camera 178.

In some implementations, the dock controller 140 may be configured to take a particular action when a certain badge is scanned at the near field communication reader 170 (or facial recognition credentials are validated). For instance, by way of non-limiting example, video feed stored at memory 232 may be automatically transmitted to a remote computing device when a site manager scans their badge. Alternatively, or in addition, the aforementioned circular buffering may stop in response to a particular scanned badge to prevent overwrite. Yet further, the dock controller 140 may enter a service mode, safe mode, or another operating state in response to a particular scanned badge.

As depicted in FIG. 4, the near field communication reader 170 may be disposed behind a screen 310. In some instances, the screen 310 may include a single-piece that extends over both the near field communication reader 170 and the screen 288. In some implementations, the screens 182 and 310 may be formed from a single piece.

FIG. 15 illustrates a partially exploded view of the dock controller 140 in accordance with an example embodiment. As depicted, the second set of circuitry 206 may be coupled to a carrier 312. In this regard, the second set of circuitry 206 can be assembled outside of the base 144 where access is easier. By way of example, the carrier 312 can include plate formed from a resilient material, like a metal. The carrier 312 can have a shape that forms a close fit with internal sides of the sidewalls 148. The carrier 312 can be installed into the base 144 and rest against the rear wall 150.

In an embodiment, one or more components associated with the first or second sets of circuitry 204, 206 may be directly connected to aspects associated with the other of the base 144 or the cover 146. That is, the circuitry may not be isolated to the respective base 144 or cover 146. For example, as described above with reference to FIG. 4, the safety switch 166 includes a rotatable dial with an elongated projection forming an interface for user engagement therewith. The rotatable dial and elongated projection extend from a front surface of the cover 146 and allow loading dock personnel to interact therewith. A switch 314 may be part of the second set of circuitry 206 associated with the base 144 and can receive input generated at the rotatable dial. The switch 314 can include, for example, a potentiometer, an encoder, a Hall Effect Sensor, a captive rotary element, an optical rotary element, a resistive switch, a detent rotary switch, an inductive sensor, or the like. A connection element, such as an elongated rod 316, can extend from the rotatable dial to the switch 314 such that movement of the rotatable dial is captured by the switch 314 through the elongated rod 316. As shown in FIG. 5, the elongated rod 316 may remain connected to the switch 314 when the cover 146 is moved to the open position. Alternatively, the elongated rod 316 may remain connected to the rotatable dial when the cover 146 is moved to the open position. When the cover 146 is then closed, the rotatable dial can regain contact with the switch 314 (or vice versa) to reestablish safety control. By way of non-limiting example, the elongated rod 316 can include a non-circular outer sidewall that mates with a complementary shaped receiving area disposed at a rear of the rotatable dial. When the cover 146 is closed, the complementary sidewall and receiving area can mate, thereby permitting transfer of rotation from the rotatable dial to the elongated rod 316. Disconnect between the rotatable dial and the switch 314 with the cover 146 in the open position may prevent accidental input to the switch 314. The loading dock personnel can manually actuate the elongated rod 316 to activate the switch 314 is necessary with the cover 146 in the open position.

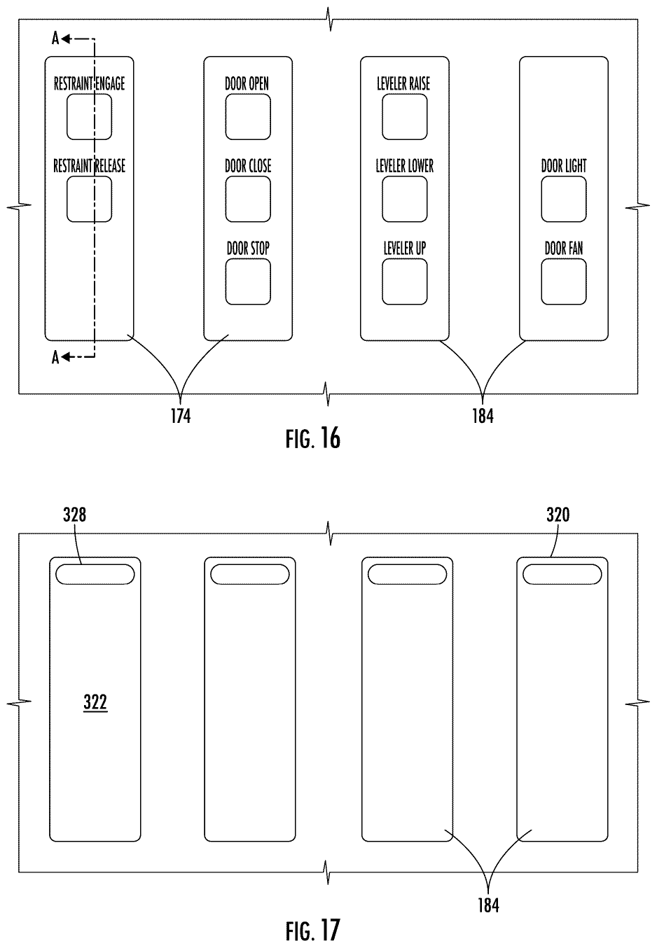

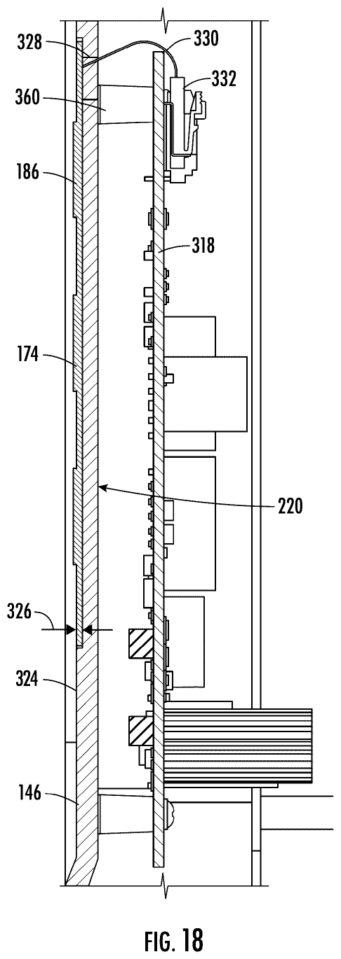

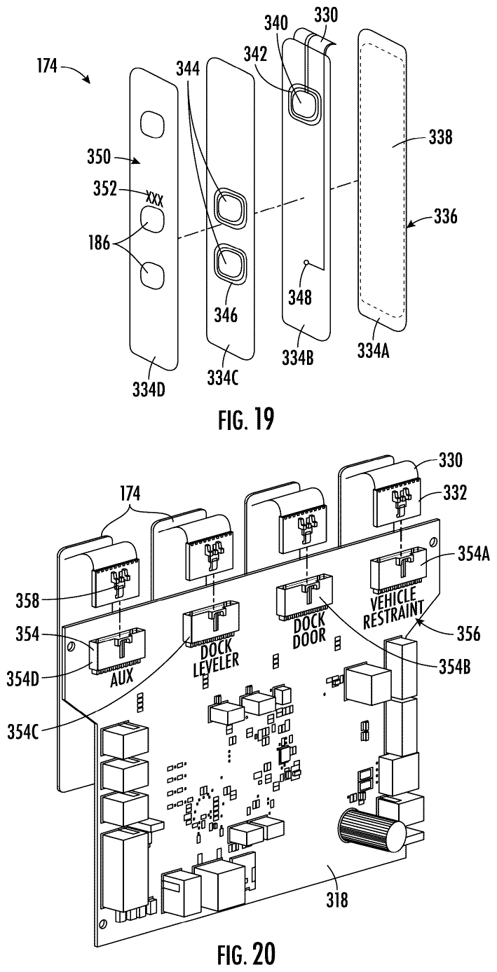

FIG. 16 illustrates an enlarged plan view of the field 172 of user interfaces 174 disposed at the cover 146 of the dock controller 140. FIG. 17 illustrates the same enlarged plan view of the field 172 as seen without the user interfaces 174 present. FIG. 18 illustrates a cross-sectional view of the cover 146 as seen along line A-A in FIG. 16. FIG. 19 illustrates an exploded view of one of the user interfaces 174 in accordance with an example embodiment. FIG. 20 illustrates an exploded view of the user interfaces 174 and a user interface control board 318 as seen with the cover 146 and other hardware components.

Referring initially to FIGS. 16 and 17, the individual user interfaces 174 can be received at the cover 146, e.g., in separate regions 184. The individual user interfaces 174 can be fungible, defining a common outer perimeter shape. The regions 184 can be sized and shaped to receive the user interfaces 174. The perimeter 320 of each region 184 can form a close fit with the received user interface 174.

Each region 184 can define a recessed bottom 322, offset from a major plane 324 of the adjacent field 172, for example, by an offset depth 326 (FIG. 18) of at least 0.5 mm, such as at least 1 mm, such as at least 2 mm, such as at least 3 mm, such as at least 4 mm, such as at least 5 mm. In some implementations, offset depth 326 is equal, or approximately equal, to a thickness of the user interface 174 making user interface 174 feel flush with the major plane 324. In other implementations, the offset depth 326 may be less than the thickness of the user interface 174 resulting in the user interface 174 extending proud of the major plane 324. In yet other embodiments, the offset depth 326 can be greater than the thickness of the user interface 174 or there may be no offset depth 326 and the user interface 174 can be coupled directly to the major plane 324. Recessing the user interface 174 by use of an offset depth 326 may allow for easier placement of the user interface 174 along the cover 146 during installation. The perimeter 320 of the region 184 can define a guide to align the user interface 174. Alternatively, or in addition, the cover 146 can include a projecting ridge, continuously or discontinuously extending around the perimeter 320 to define the region 184.

Each region 184 can include a passthrough 328. The passthroughs 328 allow circuitry 330, such ribbon circuits, (FIGS. 18, 19, and 20) of the user interface 174 to extend through the cover 146 from an external location where the user interface 174 is attached to an internal location where the user interface control board 318 is located. The passthroughs 328 may each be shaped to accommodate various circuitry 330 and associated connectors 332 (FIGS. 18 and 20). In an embodiment, the passthrough 328 defines an oval, however other shapes are contemplated herein. While each passthrough 328 is depicted in isolation, the passthroughs can be combined together into a continuous passthrough. Alternatively, the user interfaces 174 may be coupled together on an external side of the cover 146 with only one circuitry 330 passing through the cover 146. During installation of the user interface 174, the circuitry 330 is inserted through the passthrough 328 and connected to the associated connector 332 (FIG. 18). Excess circuitry 330, e.g., excess ribbon circuit, is fed into the passthrough 328 such that the user interface 174 rests flush with the recessed bottom 322. The circuitry 330 can extend from a body of the user interface 174 at a location generally corresponding to a location of the passthrough 328 relative to the region 184. The passthrough 328 can be shaped to accommodate connective elements that electrically couple the circuitry 330 to the user interface 174. In an embodiment, the circuitry 330 extends from the user interface 174 perpendicular, or generally perpendicular, therewith so as to extend directly into the passthrough 328.

Referring to FIG. 19, at least one of the user interfaces 174 may be formed from a plurality of layers, such as a first layer 334A, a second layer 334B, a third layer 334C, a fourth layer 334D, or the like. The number of layers may be greater or fewer than the four layers 334A, 334B, 334C, 334D depicted in FIG. 19. Each of the layers 334A, 334B, 334C, 334D can provide a functional aspect of the user interface 174. While the layers 334A, 334B, 334C, 334D are hereinafter described in a particular order, it should be understood that the order of the layers 334A, 334B, 334C, 334D may be adjusted or modified without deviating from the scope of the disclosure.

In an embodiment, the first layer 334A is a structural layer that provides strength and rigidity to the user interface 174. The first layer 334A may be formed from a relatively rigid material that is resistant to bending under pressure. The first layer 334A can define a first surface 336 which receives an adhesive 338, such a double-sided adhesive binder, used to bind the user interface 174 to the recessed bottom 322. The double-sided adhesive binder may be covered with a removable (e.g., peelable) layer during shipping and while the user interface 174 is in inventory to prevent the user interface 174 from attaching to nearby objects.

The second layer 334B can include one or more sensors 340, one or more backlight elements 342, or both. The sensor(s) 340 may each be associated with one of the buttons 186 (FIG. 4) and stacked thereunder. The sensor(s) 340 may include depressible, low profile sensors, such as a capacitive sensors, resistance sensors, or the like. When the button 186 is pressed by a loading dock personnel, the sensor 340 detects the associated pressure through the layer stack. The sensor 340 may communicate with the user interface control board 318 through the circuitry 330 and send a signal to the user interface control board 318 regarding the detected activation. The second layer 334B may house portions, or the entirety, of the circuitry 330, thereby connecting the sensor(s) 340 with the user interface control board 318.

Backlight elements 342 may be used in combination with one or more of the buttons 186 or in a lit area of the user interface 174. For example, the second layer 334B is depicted with a backlight element 342 extending around the sensor 340 to illuminate an opaque passthrough defined further up the layer stack around the associated button 186. The backlight element 342 can generate light which passes through the layer stack and is emitted through the opaque passthrough. The backlight element 342 may change color or animation based on an operation being performed at the dock controller 140. Similar to the sensor 340, the backlight element 342 may receive instructions from the user interface control board 318 through the circuitry 330 to affect a status of the backlight element 342. For example, as previously described, the user interfaces 174 may light up to instruct loading dock personnel of a next action to be taken at the dock controller 140. Use of the backlight element 342 to light up the appropriate button 186 may direct the loading dock personnel quickly and without requiring significant training efforts. In some implementations, all of the buttons 186 can be backlit, and more particularly, selectively backlit to direct the loading dock personnel.

The third layer 334C can include one or more additional sensors 344 associated with another button 186 of the user interface 174. The one or more additional sensors 344 can include respective backlight elements 346, or not. Alternatively, the backlight elements 342, 346 can be disposed on one common layer of the layer stack and the sensors 340, 344 can be disposed on a separate, common layer of the layer stack. Additional components of the user interface 174 can be contained within one or more layers 334A, 334B, 334C, 334D of the layer stack. The circuitry 330 may be split across two or more layers of the layer stack, such as between the third layer 334C and the second layer 334B. Alternatively, each control layer of the layer stack can include a separate circuitry 330. In yet another embodiment, the circuitry 330 can extend primarily along one of the layers 334A, 334B, 334C, 334D and pass through one or more of the layers 334A, 334B, 334C, 334D to communicate with neighboring control features (e.g., sensors and backlight elements). For example, the second layer 334B can include an electrical contact 348 which interfaces with a complementary electrical contact (not illustrated) associated with the button 186 and/or backlight element 346 to connect the button 186 and/or backlight element 346 with the user interface control board 318.

The fourth layer 334D can include a touch surface 350 configured to receive user feedback. The fourth layer 334D may define a conformal surface which readily deforms to allow the user to interface with the sensors 340, 344. In an embodiment, the buttons 186 may be defined by enlarged portions of the fourth layer 334D that project (nominally) and which deflect under user pressure. Indicia 352 can be disposed on the fourth layer 334D, e.g., near one or more of the buttons 186, to describe the button functionality.

The layers 334A, 334B, 334C, 334D can be coupled together to form a one-piece body. By way of non-limiting example, the layers 334A, 334B, 334C, 334D can be coupled together by an adhesive disposed between and around adjacent layers 334A, 334B, 334C, 334D, by a mechanical crimping process, through sonic or frictional welding, by means of a fastener which extends through the layers 334A, 334B, 334C, 334D, or the like. The layers 334A, 334B, 334C, 334D may be sealed to prevent ingress of water and other contaminants between the layers 334A, 334B, 334C, 334D. The stacked layers can be treated with a surface coating that encapsulates the layers 334A, 334B, 334C, 334D in a watertight seal, an electric-isolating material, or the like.

While the user interface 174 depicted in FIG. 19 includes a layer stack, in accordance with other embodiments, the user interface 174 can be formed from an enclosure housing one or more of the described components, through another fabrication technique, or using any other type of construction.

Referring to FIG. 20, the user interface control board 318 defines a plurality of connectors 354 each configured to interface with a connector 332 associated with one of the user interfaces 174. In the depicted embodiment, the user interface control board 318 includes four connectors 354 each interfaced with one of the user interfaces 174. In an embodiment, each connector 354 is associated with a particular user interface 174. For example, the connectors 354 can include a first connector 354A, a second connector 354B, a third connector 354C, and a fourth connector 354D. The first connector 354A is associated with the first user interface 174A, the second connector 354B is associated with the second user interface 174B, the third connector 354C is associated with the third user interface 174C, and the fourth connector 354D is associated with the fourth user interface 174D.

In some implementations, the user interfaces 174 can be swapped between the connectors 354A, 354B, 354C, 354D of the user interface control board 318. The user interface control board 318 can be configured to identify the type of user interface 174 installed at each of the connectors 354A, 354B, 354C, 354D and self-configure based on the identified type of user interface 174. This plug-and-play solution allows different combinations of layouts of the user interfaces 174 at the field 172. In other implementations, the user interfaces 174 are each assigned to a specific connector 354A, 354B, 354C, 354D. The user interface control board 318 may only operate to receive signals from the respective user interfaces 174 when appropriately connected to the correct connector 354A, 354B, 354C, 354D. Yet alternatively, each connector 354A, 354B, 354C, 354D can be associated with a particular set of loading dock component control features and apply said control features regardless of which user interface 174 is connected to which connector 354A, 354B, 354C, 354D.

In an embodiment, each of the connectors 354A, 354B, 354C, 354D is labeled with indicia 356 to identify an intended user interface 174 for use with that connector 354A, 354B, 354C, 354D. The indicia 356 may be disposed on the user interface control board 318, such as at a location adjacent to the respective connector 354A, 354B, 354C, 354D. Using the indicia 356, it is easy for a technician to retrofit the dock controller 140 with additional user interfaces 174 at a later time.

During installation of the user interface(s) 174 at the field 172, the display 168 may be configured to provide instructions for coupling the connectors 332 of the user interfaces 174 to the connectors 354 at the user interface control board 318. The instructions can depict an order of steps taken to successfully couple the user interface(s) 174 to the field 172, a spatial arrangement of the connectors 354A, 354B, 354C, 354D to ensure correct placement, or the like. The dock controller 140 may recognize when the interface between the connectors 332 and 354 is completed and automatically advance the installation instructions to a next step. In some implementations, the dock controller 140 may generate a warning where a detected user interface 174 is installed at an incorrect location, e.g., an incorrect connector 332 is received at one of the connectors 354. To resolve the warning, the installer can remove the connector 332 from the user interface control board 318, e.g., by releasing a latch 358 and pulling the connector 332 from the connector 354, and reinstall the connector 332 at the correct location.

Once the interface is established between the interface 174 and the user interface control board 318 (or at least once the connector 332 of the interface 174 is positioned to interface with the control board 318), the adhesive 338 (FIG. 19) can be revealed by removing the temporary cover material, and the user interface 174 can be bonded to the region 184. The user interface 174 may deflect during the installation process to allow the installer the ability to initially attach one end of the user interface 174 to the region 184 and then conform the user interface 174 to fully rest flat within the region 184.

Referring to FIG. 18, the user interface control board 318 may be spaced apart from the inside surface 220 of the cover 146. For example, the cover 146 can include one or more bosses 360 projecting from the inside surface 220 and to which the user interface control board 318 is mounted. The user interface control board 318 can be coupled to the bosses 360 by threaded fasteners that threadably insert into threaded openings defined by the individual bosses 360.

The dock controller 140 may include additional features and components not previously described that enhance the ability for loading dock personnel to monitor and control the loading dock area 100 (FIG. 1) through direct or indirect use of the dock controller 140. The dock controller 140 may be rapidly upgraded between various different configurations to suit the individual needs of the site manager on an ongoing basis. The base 144 and/or cover 146 can include quick attachment protocols which permit rapid reconfiguration of the dock controller 140. For example, the carrier 312 (FIG. 15) may be rapidly installed and removed along a rail system which extends into the base 144 in a forward-rearward direction or through a rotatable interface, such as a swingable frame. Alternatively, or additionally, at least some of the second circuitry 206 can be coupled to the carrier 312 (or directly to the base 144) through a quick release attachment mechanism. The carrier 312 may be designed to allow for swappable placement between the various components. In this regard, internal components can be moved around within the dock controller 140 to allow room for new or future components to allow the dock controller 140 to grow with the changing needs of the site manager.

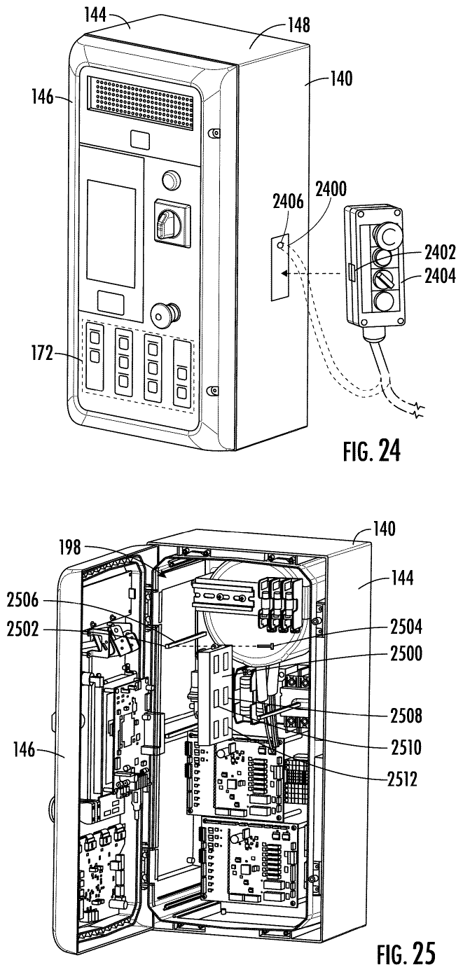

In an embodiment, the dock controller 140 may be retrofit with one or more modular attachments. The modular attachment(s) can be retrofit with the dock controller 140 in situ in the loading dock environment. For example, referring to FIG. 24, one or more sidewalls 148 of the base 144 can include an attachment interface 2400 to which a complementary attachment interface 2402 can be coupled. In some implementations, the attachment interface 2400 and complementary attachment interface 2402 can form a quick-release engagement whereby a modular attachment 2404 can be quickly installed and/or removed from the dock controller 140. The quick release engagement can be formed by a snap fit connection, a twist-to-lock connection, sliding engagement, a magnet-based connection, a bayonet coupling, a spring-loaded ball-detent, a cam lock, hook-and-loop fastener, an adhesive, or any combination thereof. In other implementations, the attachment interface 2400 and the complementary attachment interface 2402 can form a permanent, or semi-permanent, engagement. The complementary attachment interface 2402 can be coupled with, integral with, or otherwise provided at the modular attachment 2404. While the modular attachment 2404 is depicted in FIG. 24 as being attached to the dock controller 140 along a lateral portion of the sidewall 148, in other instances, the modular attachment 2404 may be attached to an upper or lower portion of the sidewall 148. Alternatively, or in addition, the modular attachment 2404 may be coupled to the cover 146.

The modular attachment 2404 may be retrofit to the dock controller 140 without requiring opening of the cover 146. In some implementations, the base 144 and/or cover 146 can include a pathway 1406 through which wiring can be extended to connect the modular attachment 2404 with one or more components housed by the dock controller 140. In other implementations, the modular attachment 2404 may be configured to wirelessly communicate with one or more components of the dock controller 140 via a wireless communication protocol. In yet other implementations, the modular attachment 2404 may operate without communicating with components of the dock controller 140. In this regard, the modular attachment 2404 may be positioned at the dock controller 140 without affecting operations performed by the dock controller 140.

In an embodiment, the modular attachment 2404 may be coupled to the dock controller 140 at a location associated with other hardware components. For example, the modular attachment 2404 may be coupled to the dock controller 140 at field 172, e.g., when the dock controller 140 is not actively utilizing all of the regions 184 (FIG. 17) to support user interfaces 174. The modular attachment 2404 may be installed at the field 172, e.g., at one or more of the regions 184. The passthrough(s) 328 may be utilized to feed circuitry of the modular attachment 2404 to one or more components housed in the dock controller 140 for electrical connection therewith. In some instances, the modular attachment 2404 may act similar to, or even the same as, one or more of the user interfaces 174.

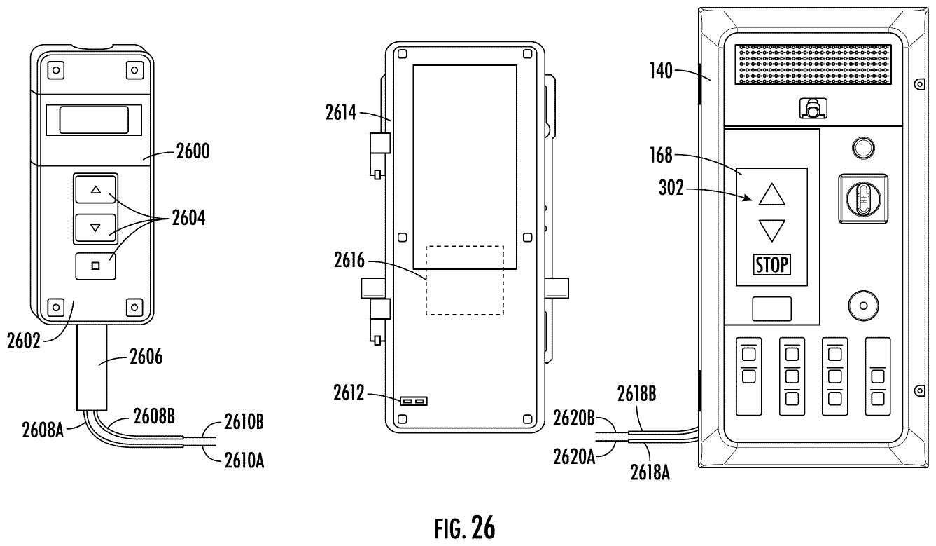

Referring to FIG. 25, in some instances a modular attachment 2500 may be mountable within the interior volume 198 of the dock controller 140. For example, the interior volume 198 can define one or more attachment interfaces 2502 to which a complementary attachment interface 2504 can be coupled. In an embodiment, the attachment interfaces 2502 can include threaded openings which receive fasteners of the complementary attachment interface 2504. The modular attachment 2500 can define openings located to accept fasteners aligned with the threaded openings. In some implementations, the attachment interface 2502 and complementary attachment interface 2504 can form a quick-release engagement whereby a modular attachment 2500 can be quickly installed and/or removed from the interior volume 198 of the dock controller 140. The quick release engagement can be formed by a snap fit connection, a twist-to-lock connection, sliding engagement, a magnet-based connection, a bayonet coupling, a spring-loaded ball-detent, a cam lock, hook-and-loop, or any combination thereof. In other implementations, the attachment interface 2502 and the complementary attachment interface 2504 can form a permanent, or semi-permanent, engagement. The complementary attachment interface 2504 can be coupled with, integral with, or otherwise provided at the modular attachment 2500. While the modular attachment 2500 is depicted in FIG. 26 as being attached to a post or boss 2506, in other instances, the modular attachment 2500 may be attached directly to the base 144 or indirectly attached through a different attachment protocol. Alternatively, or in addition, the modular attachment 2500 may be coupled to the cover 146 such that the modular attachment 2500 moves with the cover 146 when the dock controller 140 is opened. Alternatively, or in addition, the modular attachment 2500 may be movable coupled to one or both of the base 144 and/or the cover 146.

In some implementations, the modular attachment(s) 2404, 2500 may be movably coupled to the dock controller 140, e.g., via an adjustable attachment protocol. For example, a bracket (or other support structure) can extend between the dock controller 140 and the modular attachment 2404, 2500. The bracket can include one or more adjustable interfaces that allow the modular attachment 2404, 2500 to be repositioned between two or more in-use configurations such that loading dock personnel can customize the position of the modular attachment 2404, 2500 based on the surrounding environment or other considerations. In other implementations, the modular attachment 2404, 2500 may be statically coupled to the dock controller 140 such that after engagement, the relative position of the modular attachment 2404, 2500 remains fixed with respect to the dock controller 140.

Modular attachment(s) 2404, 2500 may be selectable from a wide range of retrofittable components. For example, the modular attachment(s) 2404, 2500 may be selected from a group of components including supplemental input hardware configured to add physical control capability to the dock controller 140 (e.g., a button panel or keypad expansion, a rotary knob encoder, a slide controller or dial attachment, a touchpad, a joystick or other multi-axis converter, a paddle shifter, a foot-triggerable attachment, etc.), supplemental signal-interpreting modules configured to passively or actively affect signals into and/or out of the dock controller 140 (e.g., a passive signal monitor, an inline signal conditioner, a protocol translator, a signal interceptor, a sensor fusion attachment, etc.), supplemental output hardware configured to add awareness and/or feedback, e.g., to nearby loading dock personnel (e.g., an LED status bar, a clip on display module, an indicator panel, a haptic feedback module, a voice or buzzer notification, a smart-lighting module, a laser alignment or guide module, etc.), a sensory enhancement module configured to provide supplemental environmental context to the dock controller 140 (e.g., a position and/or orientation sensing attachment, an optical sensor, a directional proximity sensor, a barcode or QR reader, a biometric reader, a capacitive sensor, a camera, etc.), a communication module configured to retrofit connectivity with the dock controller 140 (e.g., a plug-on transmitter, a wired-to-wireless bridge dongle, a cellular modem, a docking module that enables controller network effect), a safety compliance module (e.g., an emergency-stop button, a key-based lockout, a tamper-detection module, a guard or shield, etc.), a power interface configured to draw, store, and/or regulate power to the dock controller 140 or a component attached to the dock controller 140 (e.g., a removable battery pack, power regulating circuitry, wireless charging, etc.), a middleware module configured to affect operation of the dock controller 140 or a component attached to the dock controller 140 (e.g., an AI-intelligence unit having an integrated machine learned (ML) model or in communication with a remote device hosting an ML model, a macro-sequencing module, a gesture interpretation module, a task-context based module, etc.), or the like.

The modular attachment(s) 2404, 2500 can include control circuitry 2508 and communication interface 2510 (e.g., a wired or wireless interface for transmitting and/or receiving signals) (see FIG. 25). The control circuitry 2508 can include a processor coupled to memory. The memory can store instructions which affect operation of the modular attachment (2404, 2500). In some instances, the instructions can include identifying information which identifies an attribute of the modular attachment(s) 2404, 2500. In some instances, the identifying information may be associated with a particular manufacturer. The identifying information may be detected by the dock controller 140 and used to automatically self-configure the modular attachment(s) 2404, 2500 and/or the dock controller 140 to operate together. The instructions may also, or alternatively, be configured (programmed) to allow the modular attachment(s) 2404, 2500 to operate with the dock controller 140. For instance, the modular attachment(s) 2404, 2500 may be configured to receive an input signal from the dock controller 140 and perform a specific operation in view of the received input signal. For example, the modular attachment 2404, 2500 may provide an auxiliary (add on) functionality not previously implemented at the dock controller 140, like providing illumination near the loading dock area in dark lighting conditions. The instructions may store a database of response logic, including a plurality of associations. Upon receiving a particular input, the processor identifies a corresponding entry in the stored instruction set and generates the associated output or initiates the associated operation. By way of example, when the camera 178 detects a low light condition, a signal generated by the dock controller 140 may be received by the communication interface 2510 causing the control circuitry 2508 to energize a light 2512 of the modular attachment(s) 2404, 2500.

The dock controller 140 may be retrofit with third-party modular attachment(s) 2404, 2500. In some implementations, the third-party modular attachment(s) 2404, 2500 may not permit self-configuration with the dock controller 140. For example, the third-party modular attachment(s) 2404, 2500 may not be included in the database of response logic. In this instance, the dock controller 140 may initiate a manual configuration protocol through which loading dock personnel, or remote personnel, may configure the third-party modular attachment(s) 2404, 2500 to the dock controller 140. In some implementations, the manual configuration protocol can include use of the display 168. For example, the display 168 can display information associated with a pairing process to configure the third-party modular attachment(s) 2404, 2500. The dock controller 140 can then receive user input which allows for configuration of the third-party modular attachment(s) 2404, 2500.

In some implementations, the third-party modular attachment(s) 2404, 2500 may self-configure the dock controller 140 in response to an update, e.g., a firmware update. For example, the dock controller 140 may perform a firmware update in response to detecting the third-party modular attachment(s) 2404, 2500. The dock controller 140 can query a repository in response to detecting unknown third-party modular attachment(s) 2404, 2500. Alternatively, or in addition, the loading dock personal can interact with the dock controller 140 to perform the update. In some implementations, the dock controller 140 can include a connection port. The loading dock personnel may interact with the connection port, e.g., using a thumb drive or other removable hardware, to update the dock controller 140 to operate with the third-party modular attachment(s) 2404, 2500.

FIG. 21 illustrates a top plan view of the loading dock area 100 in accordance with an example embodiment. The loading dock area 100 is seen with a plurality of dock controllers 140 attached to a common wall 142, including a first dock controller 140A, a second dock controller 140B, and a third dock controller 140C. The first dock controller 140A is disposed between a first loading dock 102A and a second loading dock 102B. The second dock controller 140B is disposed between the second loading dock 102B and a third loading dock 102C. The third dock controller 140C is disposed between the third loading dock 102C and a fourth loading dock 102D. Each of the dock controllers 140A, 140B, 140C includes an integrated camera 178 defining a field of view FOV1, FOV2, FOV3. The fields of view FOV1, FOV2, FOV3 are all offset mounted, covering a greater spatial area at the left side loading dock 102 than at the right side loading dock 102. As previously described, this configuration may be inverted, for example, by inversely mounting the bracket 222 (see, e.g., FIG. 6) relative to the cover 146 to instead cover a greater spatial area at the right side loading dock 102 than the left side loading dock 102.

In view of the depicted offset, the first dock controller 140A is associated with the first loading dock 102A, the second dock controller 140B is associated with the second loading dock 102B, and the third dock controller 140C is associated with the third loading dock 102C. It should be understood that further dock controllers 140N may be associated with yet further loading docks 102N. For instance, a fourth dock controller (not illustrated) may be associated with the fourth loading dock 102D.

FOV1, FOV2, FOV3 each define independently-observable portions 362 of the loading dock area 100, referred to hereinafter as non-overlapping FOV, where only one camera 178 detects activity. FOV1, FOV2, FOV3 can also define overlapping-observable portions 364 where at least two cameras 178 detect activity. While not depicted in the illustrated embodiment, in some loading dock areas 100 some portions of the loading dock area 100 can be simultaneously monitored by three, four, five, or even ten different cameras 178.

One or more of the cameras 178 may be configured to operate in a normally-on state whereby image data is continuously captured and/or a normally-off state whereby image data is captured only in response to a triggering threshold. By way of non-limiting example, the triggering threshold can include detection of vehicle presence at the loading dock 102 associated with the camera 178, detection of an opening or closing of a door (e.g., a vehicle door, facility door, or the like) by a door-monitoring sensor and/or receipt of an open or close command (e.g., a command generated by or received at a movable barrier operator), an equipment trigger (e.g., in response to equipment arriving at the loading dock 102 or performing some action at the loading dock 102), in response to a manual input from loading dock personnel (e.g., actuation of a user-actuatable input, input received by a touch-sensitive input, etc.), in response to a loading dock action (e.g., reconfiguration of a movable barrier from a closed position to an open position), or the like. The camera(s) 178 may be controlled, e.g., by the dock controller 140, to begin capturing image data. The camera(s) 178 may capture image data for a fixed duration of time (e.g., 30 seconds, 60 seconds, or more). Alternatively, or in addition, the camera(s) 178 may capture image data until occurrence of a secondary triggering threshold (e.g., departure of the vehicle from the loading dock 102, closing of the door, etc.).

In an embodiment, the camera(s) 178 can be controlled to capture image data based on a status of the dock controller 140 or a state of the loading dock 102 as detected by the dock controller 140. In some implementations, the dock controller 140 may be configured to generate a visual indication associated with a current status of the loading dock 102. For example, a lighting system may be controlled to display a first color (e.g., red) when the loading dock 102 is in a first state (e.g., the vehicle restraint is not engaged with a vehicle) and display a second color (e.g., green) when the loading dock 102 is in a second state different than the first state (e.g., the vehicle restraint is engaged with the vehicle). The camera(s) 178 can be controlled to automatically capture image data in response to a state of the loading dock 102 indicative of the second state but not the first state. The camera(s) 178 can be controlled to continuously capture image data until the loading dock 102 returns to the first state, for a fixed duration of time, or the like.

As previously described, camera feed (e.g., image(s) and video(s) captured in the FOV of the camera(s) 178) can be stored locally at the dock controllers 140 in memory 232 (FIG. 6). The camera feed may be recalled for viewing locally at the dock controller 140, e.g., at the display 168. Alternatively, or in addition, the camera feed can be transmitted to a remote location, e.g., via the network 136 (FIG. 1). The camera feed can be stored, accessed, edited, and/or viewed at a remote computing device located at the remote location. The remote location may include, for example, an onsite management office, an onsite server room, an offsite server, a smart device (e.g., a smartphone, tablet, or other mobile computing device), or the like. Users can access the camera feed in real time and/or access a saved log for historical camera feed.

In some implementations, viewing may be limited by credentialing. For example, some entities may be credentialed only for local viewing of the image data, e.g., video feed, at the display 168 of the dock controller 140. Other entities may be credentialed for remote viewing. Yet other entities may be credentialed for both local and remote viewing of the image data, e.g., the video feed. In some implementations, credentials may also delineate access to real time and/or stored video feed. In this regard, tiered viewing is possible to limit intruder access and increase privacy of potentially sensitive loading dock areas. Where in-person viewing at the display 168 is desired, a viewer may be required to scan their badge or be identified by the camera 178 to validate credentials. Once validated as having sufficient credentials, the viewer may be able to interact with the camera feed to inspect activity at the dock controller 140 more thoroughly.

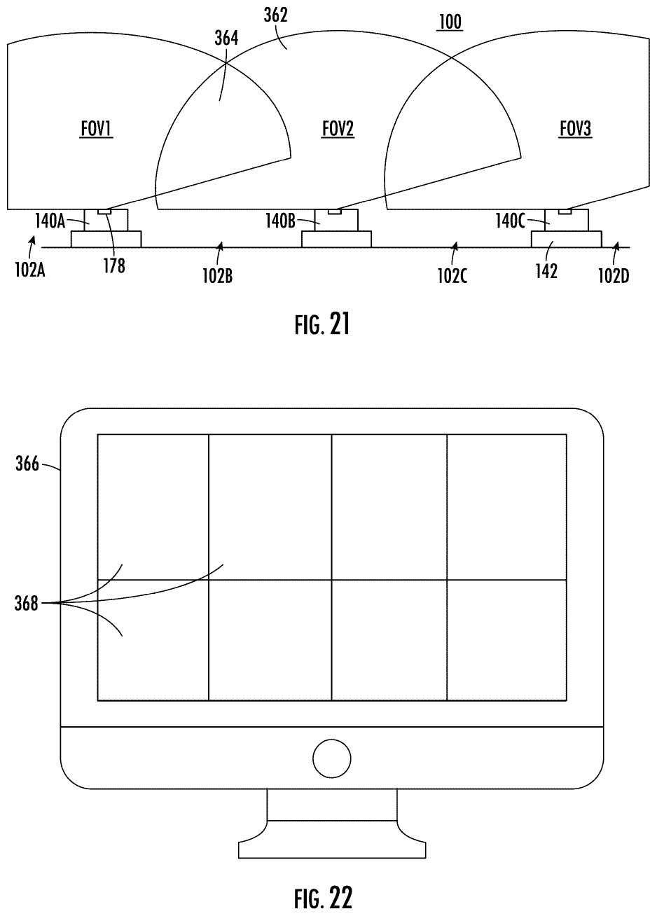

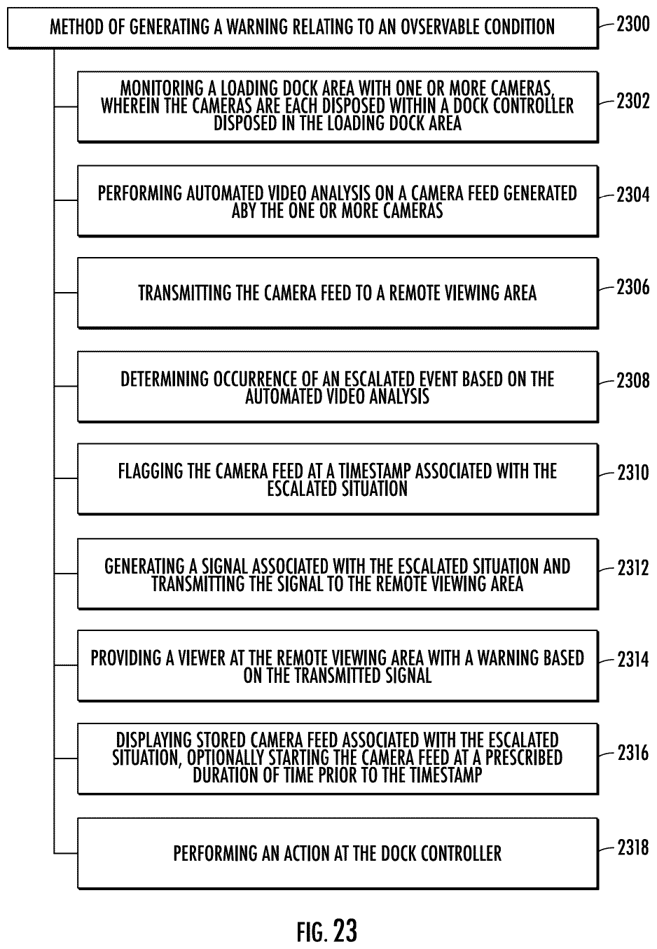

FIG. 22 illustrates a display 366 located at an onsite management office in accordance with an embodiment. The display 366 executes an application interface (API) to render the camera feed from one or more of the dock controllers 140. For example, the API can define a plurality of containment structures, such as boxes 368, each of which contains camera feed captured by a camera 178 associated with one of the dock controllers 140. The camera feed rendered in each box 368 can rotate between the dock controllers 140 on a rolling basis (e.g., time dependent), in response to a detected condition (e.g., movement detected at a particular dock controller 140), based on user instruction, or the like.

In an embodiment, the camera feed from at least two dock controllers 140 may be stitched together to form an enlarged (jumbo) view of the loading dock area 100. The various camera feeds may be stitched automatically, e.g., using a stitching program that determines pixel boundaries to generate shape recognition and then stitches multiple camera feeds together based on recognized shapes. The stitched feed may be rendered on the display 366 for viewing. In some instances, the viewer may select between a plurality of camera feeds to generate the stitched camera feed. For example, the user can select between two or more boxes 368 and the program can automatically stitch the camera feed between the two or more boxes 368 when sufficient overlapping pixel boundaries are detected. Yet other techniques of stitching the various camera feed may be employed, including, for example, optical flow-based stitching, feature-based stitching, and/or even deep learning-based stitching (based on machine learning algorithms). These techniques may rely on template matching, feature-based matching (e.g., Scale-Invariant Feature Transform, Speeded-Up Robust Features, Oriented FAST and Rotated BRIEF, etc.), histogram of oriented gradients (HOG), convolutional neural networks (CNN), region-based CNN (R-CNN), Single Shot Multibox Detector (SSD), Faster R-CNN, Mask R-CNN, Saliency Detection, Semantic Segmentation, Deep Reinforcement Learning (DRL), or the like. This and other processing may be performed at the dock controller 140, e.g., using onboard processors running executable programs, and/or at one or more remote computing devices.

The display 366 may be configured to display a warning or error notification in the event of a detected issue at the loading dock area 100. For example, if a forklift driver impacts a pallet in the loading dock area, the display 366 may render a notification for the viewer. The notification may be generated at the display 366 (e.g., using a processor coupled to the display 366), at the dock controller 140, at an intermediate computing device, or any combination thereof. Similarly, if a forklift is observed travelling in excess of a prescribed travel speed (e.g., 5 miles per hour), the display 366 may render a notification for the viewer. Similarly, if a loading dock personnel is determined to be injured, sick, or in need of assistance, the display 366 may render a notification for the viewer. Similarly, if one or more of the loading dock components loses signal or malfunctions, the display 366 may render a notification for the viewer. Similarly, the dock controller 140 may be used to detect health of nearby loading dock personnel and others using contactless monitoring techniques. For example, the dock controller 140 can rely on camera feed, e.g., from the camera 178, or other sensors (contained at the dock controller 140 or in the nearby environment) to monitor vital signs of loading dock personnel, such as forklift drivers. Example vital signs include heart rate (pulse), respiratory rate, blood oxygen saturation (SpO₂), body temperature, blood pressure, pupil dilation, etc. The dock controller 140, or an external processor, can apply a technique (e.g., machine learning) to extract the vital sign information from the camera and/or sensor feed. The dock controller 140 can evaluate and recognize issues with loading dock personnel prior to an accident and notify a relevant party to take action. For example, the dock controller 140 may detect dilated or constricted pupils and determine, alone or in view of secondary data, that a member of the loading dock personnel is under the influence of a chemical. In another example, the dock controller 140 may detect an elevated respiratory rate and, alone or in view of secondary data, determine that a member of the loading dock personnel is in distress and requires medical attention. In both cases, the dock controller 140 may generate an alert (local or remote) to incur assistance for the loading dock personnel member. The above examples are merely illustrative; other observable events may warrant notification rendering.

In some implementations, camera feed from multiple dock controllers 140 is stitched together to generate a stitched event notification. For example, where a forklift is detected impacting a pallet in the loading dock area, multiple cameras may have observed the impact from different angles. Additionally, one or more other cameras may have observed the forklift moving towards the pallet prior to impact. The camera feed from these different cameras can be stitched together to provide greater insight into the nature of the impact.

Stitching may occur locally at the dock controller(s) 140. For example, onboard processing of each or multiple dock controller(s) 140 may generate the stitched event using techniques like template matching, feature-based matching, HOG, CNN, R-CNN, SSD, Faster R-CNN, Mask R-CNN, Saliency Detection, Semantic Segmentation, DRL, or the like. Alternatively, or in addition, stitching may occur at one or more of the remote computing devices using feed transmitted from the dock controller(s) 140 using one or more of the same or different technique(s). Additional contextual information may be provided in the stitched event notification, such as for example, date, time, location, and the like. In some instances, machine learning (ML) and/or large language models (LLM) may be used to generate textual summaries of the event.

FIG. 23 depicts a flowchart of an example method 2300 of generating a warning relating to an observable condition at the loading dock area. The method 2300 may be performed using one or more of the previously described features, such as the dock controller 140, the camera 178 integrated with the dock controller 140, one or more onboard processors located at the dock controller 140, the display 366, a remote computing device, or the like. Although FIG. 2300 depicts operations performed in a particular order for purposes of illustration and discussion, the method is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 2300 includes monitoring 2302 a loading dock area with one or more cameras. The cameras may be disposed within dock controllers (such as the dock controller 140) located within an interior of the loading dock area. The dock controllers 140 may face directly inside the loading dock area with the cameras providing visual feed associated therewith.

Each dock controller can include its own camera fully retained within the housing of the dock controller. The cameras each have a field of view facing into the loading dock area. In an embodiment, the field of view of at least one camera can be segmented into a plurality of zones defining at least two zones. The zones may be horizontally stacked, vertically stacked, diagonally stacked, user set based on specific features in the loading dock area, or any combination thereof. In some instances, all of the zones are monitored the same. For example, all of the zones may be monitored for passing traffic (e.g., equipment, loading dock personnel, freight, etc.), anomalies, and the like. In other instances, at least two of the zones may be hierarchically monitored with different levels of monitoring occurring in each zone. For example, the zones can be split based on proximity to the adjacent loading dock. The closer a given zone is to the adjacent loading dock, the greater an amount of scrutiny or monitoring sensitivity. Conversely, distant zones (e.g., zones well inside of the loading dock area) may be subject to lower scrutiny or monitoring sensitivity.

In some implementations, monitoring 2302 may be actively performed on an ongoing basis, such as 24 hours per day, 365 days per year. As such, continuous camera feed is generated at all times. The camera feed may be stored locally and/or remotely on a rolling basis, optionally with circular buffering.

In other implementations, monitoring 2302 may be passive, i.e., not always capturing camera feed. For example, the camera may be normally inactive (i.e., not capturing camera feed) until occurrence of a detected condition (e.g., motion detection), a detected threshold (e.g., a sensed light intensity level), upon receiving a wake command (e.g., from loading dock personnel at the loading dock area or the remote computing device), upon activation of one or more of the loading dock components, upon a detected event triggered by one or more of the loading dock components (e.g., the movable barrier operator activates to open the movable barrier), upon detecting a vehicle present at the loading dock area, upon detecting an issue with one or more of the loading dock components, etc.

One example detected condition that triggers activation of the camera is motion detection. Motion detection may be triggered by the camera itself, by a separate motion tracking component of the dock controller 140 (e.g., an IR detector), or the like. Upon detecting motion, the camera can activate from the normally inactive state (e.g., a sleep mode) to capture camera feed. The camera can remain active, for example, until expiration of a countdown timer which commences countdown from a final detected motion in the camera field of view. One example detected threshold is a detected lighting level in the loading dock area. Upon detecting lighting level above or below a prescribed level, the camera can activate from the normally inactive state to capture camera feed. Low light conditions might be associated with nighttime when the loading dock is not in use. The camera can automatically inactivate to save memory and reactivate when lighting improves (e.g., when loading dock lights are turned on to initiate the workday).

In an embodiment, in addition to using the camera integral with the dock controller, monitoring 2302 may further include use of other image capture devices (e.g., cameras) positioned about the loading dock area. Referring again to FIG. 1, the loading dock area 100 may include other internally-facing cameras (such as camera 118) and externally-facing cameras (such as camera 116). The camera feed(s) from such additional camera(s) may be received at the dock controller and monitored using techniques described herein. In some cases, the camera feed(s) from other cameras can be stored at the dock controller (e.g., at memory 232), optionally with circular buffering.

The method 2300 further includes performing 2304 automated video analysis on the camera feed generated by the one or more cameras. Automated video analysis can leverage algorithms, machine learning (ML), and/or artificial intelligence (AI), to analyze video data for detecting and identifying specific events, behaviors, and/or anomalies. Automated video analysis may include, for example, motion detection (e.g., using consecutive frame comparative analysis), object detection (e.g., using a convoluted neural network (CNN)), facial recognition, license plate recognition (LPR), anomaly detection, people counting, behavior recognition, object tracking (e.g., using a Kalman filter, optical flow, or deep learning-based tracker), background subtraction, event detection, traffic flow analysis, object classification, fall detection, scene segmentation, depth estimation and reconstruction, speed and sound recognition, human pose estimation, or the like. Automated video analysis can be performed locally at the dock controller and/or remotely by an automated video analysis program. Automated video analysis may occur on an ongoing basis, such as 24 hours per day, 365 days per year. In some instances, automated video analysis may generate metadata that is stored, e.g., together with the camera feed at local and/or remote memory.

In some instances, the automated video analysis performed at step 2304 may initiate in response to the camera activating from the inactive state based on motion detection in the camera field of view. In these instances, and other instances, automated video analysis can include tracking the object(s) that triggered activation (and optionally other objects within the field of view). The automated video analysis program can make predictions from observable information. For example, the automated video analysis program may predict a projected future path of the object(s) within the loading dock area. The projected future path may be used by the dock controller, or another processing unit, to predict collisions between the object(s) and other objects within the loading dock area, to generate user guidance or warnings at the dock controller or a remote computing device, or the like.

The automated video analysis program may also track the status of one or more loading dock components captured in the camera field of view. For example, the automated video analysis program may determine a state of the movable barrier 104 (FIG. 1), the movable barrier operator 106 (FIG. 1), the dock leveler 112 (FIG. 1), or the like. The automated video analysis program may predict a status of the loading dock component(s) based on observed movement thereof. For example, the automated video analysis program may observe the movable barrier taking longer than usual to open. The automated video analysis program may generate a warning (which may be optionally displayed on the screen of the dock controller) that signals for loading dock personnel to check the movable barrier and associated loading dock components.

In some implementations, the automated video analysis program may be used to track vehicle presence at the outside of the loading dock. For example, using camera feed from the exterior camera 116, the automated video analysis program may determine arrival of a vehicle at the dock controller. The automated video analysis program may detect and extract information from the camera feed to determine the identity of the vehicle. The determined identity can be referenced against a log of known vehicle identities to determine exactly which vehicle is currently at the loading dock. In some instances, the screen of the dock controller can display information associated with the vehicle. For example, the screen can display whether the vehicle is the expected vehicle or an unexpected vehicle, the type of freight carried by the vehicle, the type of equipment necessary to service the vehicle (e.g., load and/or unload the vehicle), the number of loading dock personnel scheduled to service the vehicle, the estimated time necessary to complete service of the vehicle, any special considerations required to fully secure the vehicle at the loading dock, or the like. The loading dock personal may interact with the dock controller as previously described to prepare the vehicle for service.

In some implementations, the automated video analysis program can track activity at the loading dock area. For example, the automated video analysis program can track a number of trips that loading dock personnel and/or equipment make into a vehicle trailer, a number of pallets extracted from or introduced to the vehicle trailer, a number of passes completed by loading dock personnel (e.g., to determine whether any personnel might remain within the vehicle trailer), freight movement through the loading dock area, or the like. In some instances, the automated video analysis program may recognize markings and/or signage contained on the freight and cross reference the recognized markings and/or signage with known markings and/or signage to determine whether the vehicle was carrying the correct freight. In some implementations, the automated video analysis program can recognize a state or condition of the freight as it passes through the loading dock area. The automated video analysis program can.

The recognized state or condition for later recall, for example as part of insurance or fraud claims. Yet other validation and identification processes can be performed by the automated video analysis program.

In some implementations, the method 2300 further includes transmitting 2306 camera feed to a remote viewing area, such as the display 366. Transmission 2306 can occur in real time or delayed (e.g., using a stored camera feed). In some instances, transmission 2306 occurs in response to a user request. In other instances, transmission 2306 may be ongoing in real time. In an embodiment, the camera feed may be displayed locally at the dock controller, such as on the screen.

The method 2300 can further include determining 2308 occurrence of an escalated event based on the automated video analysis. As used herein, an escalated event may refer to a specific event, behavior, or anomaly that warrants further attention. Previously provided examples include onsite impact (e.g., between a moving forklift and loading dock personnel or freight), danger to loading dock personnel, equipment malfunctions, and the like. This list is not meant to be exclusive and may include yet other types of incidents detected by the dock controller. The determination 2308 may be made automatically, e.g., by the dock controller 140 or the remote processor performing 2304 the automated video analysis.

In some instances, the dock controller camera may be configured to capture images at variable levels of image quality. For example, the camera may be configured to capture video at 240p, 1080p, or even 4K image quality. In response to determining 2308 occurrence of the escalated event, the camera may increase captured image quality level from a first image quality (e.g., 240p) to a second image quality (e.g., 1080p) higher than the first image quality.

In some instances, the dock controller can include a microphone which is activated when an escalated event is determined 2308 to have occurred. The audio captured by the microphone may be stored at memory of the dock controller or one or more of the remote computing device(s).

The method 2300 further includes flagging 2310 the camera feed at a timestamp associated with the escalated event. Flagging 2310 may include annotating or marking the camera feed for quick reference. In some implementations, flagging 2310 can include tagging the camera feed with a single type of tag. The single type of flag may be indicative of the occurrence of an escalated event. In other implementations, flagging 2310 can include grading the tagged event with one of a plurality of tags. The plurality of tags can be graded, for example, between low importance and critical importance. The tags may be generated in view of preset threshold conditions and/or machine learning models.

Flagging 2310 may include the tagging of metadata or other information to the camera feed. For example, the flagged event may include identifying information like what event triggered the flag. The identifying information may be generated, e.g., by a large language model (LLM) trained using a machine learning model. Example identifying information may include, “Impact between two objects”, “Loading dock personnel danger”, “Security threat detected”, or the like. The metadata may include the time associated with the escalated event, the date associated with the escalated event, the location associated with the escalated event, and the like.

The method 2300 can further include generating 2312 a signal associated with the escalated event and transmitting the signal to the remote viewing area. The method 2300 can also include providing 2314 a viewer at the remote viewing area with a warning based on the transmitted signal.

The method 2300 further includes displaying 2316 stored or real time camera feed associated with the escalated event. In some implementations, displaying 2316 the camera feed may occur automatically. In other implementations, displaying 2316 the camera feed may occur in response to the viewer interacting with the warning provided at step 2314. Displayed camera feed may begin playback some duration of time (e.g., 15 seconds) prior to occurrence of the escalated event.

The method 2300 may further include performing an action 2318 at the dock controller. For example, the dock controller may be caused to initiate a safe mode operation, to raise the dock leveler in response to a dangerous condition, to secure the movable barrier (e.g., in response to a detected intruder), or the like. These actions 2318 may occur in response to one or more of the aforementioned steps associated with the method 2300. For example, upon occurrence of an escalated event as determined at step 2308, the dock controller may reference a lookup table or rely on machine learning to determine a necessary action 2318 to take at the loading dock. In some instances, the action taken at step 2308 may even relate to a neighboring or distance dock controller. For example, where the escalated event corresponds to a runaway forklift moving towards a neighboring loading dock, the action 2308 may include notifying the associated dock controller which generates an audible and/or visible alert to nearby loading dock personnel to take cover. Additionally, or alternatively, the neighboring dock controller may evaluate and/or activate one of the loading dock components to protect the loading dock personnel from injury.

Typically, commercial movable barrier operators are in the form of jackshaft operators mounted to a wall near the movable barrier. A jackshaft operator includes a motor configured to rotatably drive a drive shaft (sometimes referred to as a jackshaft) to raise and lower a movable barrier between open and closed positions. Commercial movable barrier operators include wired wall controllers that allow loading dock personnel to control a state of the motor. For example, the wired wall controller can cause the motor to rotate in a first direction to raise the movable barrier. The wired wall controller can also cause the motor to rotate in a second direction opposite the first direction to lower the movable barrier. The wired wall controller can yet further cause the motor to stop, such as when moving between the open and closed positions. The wired wall controller includes a user interface, typically in the form of buttons, which, when individually selected by loading dock personnel, cause the movable barrier operator to perform one of raising the movable barrier, lowering the movable barrier, or stopping (arresting) further travel of the movable barrier. The raising and lowering buttons may be in the form of up and down buttons with up and down arrows, respectively.

When provisioning a movable barrier operator, such as during initial setup of the movable barrier operator, it is important to establish end ranges in which movement of the movable barrier is to be kept within. These end ranges are frequently referred to as travel limits or travel stops. The provisioning process is performed using the wired wall controller. More particularly, setting the end ranges is frequently done by advancing the movable barrier towards one end of travel using one of the buttons on the wired wall controller. With the movable barrier at the desired end of travel, a first travel limit is set. The movable barrier is then advanced to the other end of travel. With the movable barrier at the desired other end of travel, a second travel limit is set. The first and second travel limits may establish open and closed positions which, when reached, prevent the movable barrier from further travel.

The dock controller described herein may be configured to operate the movable barrier operator in a similar manner as the wired wall controller without requiring electrical connection of the wired wall controller to the movable barrier operator.

Referring to FIG. 26, a wired wall controller 2600 is depicted in accordance with an example embodiment. The wired wall controller 2600 includes a housing 2602 in which control circuitry is disposed. A plurality of buttons 2604 are selectable from outside of the housing 2602. The buttons 2604 can include an up button, a down button, and a stop button. The wired wall controller 2600 may alternatively include fewer or greater than three buttons 2604. The buttons 2604 may be push buttons. Movement of the buttons(s) 2604, e.g., actuation of the button(s) 2604 to a depressed (pushed) state, may be detected by one or more sensors contained in the housing 2602. In response to detecting movement of one or more of the buttons 2604, the sensor(s) can generate a control command which is configured to be transmitted from the wired wall controller 2600 of a movable barrier operator.

A cable 2606 extends from the housing 2602 of the wired wall controller 2600. The cable 2606 typically includes a jacket 2608 surrounding two wires-a first wire 2608A and a second wire 2608B. Each of the first and second wires 2608A, 2608B can include a central conductor 2610A, 2610B (e.g., an electrically conductive wire), which, when electrically connected to communication circuitry, such as a terminal 2612 defined by an associated movable barrier operator 2614, forms a two wire-circuit, allowing loading dock personnel to control a motor 2616 of the movable barrier operator 2614 to raise and lower the movable barrier using buttons 2604 of the wired wall controller 2600.

Movable barrier operators 2614 are typically sold and shipped with the wired wall controller 2600 included (or even preinstalled with the movable barrier operator 2614). As such, loading dock personnel can easily provision the movable barrier operator using the wired wall controller 2600. However, after provisioning, it is common for the wired wall controller 2600 to be uninstalled and placed aside and/or discarded in favor of a dock controller, like the dock controller 140 described herein. Typically, other dock controllers allow for control of the movable barrier operator 2614 after provisioning is completed, however, other dock controllers typically lack the ability to provision the movable barrier operator 2614. Thus, in the case where later provisioning is required, e.g., when replacing a movable barrier driven by the movable barrier operator 2614, the original wired wall controller 2600 needs to be reinstalled with the movable barrier operator 2614 (that is, if the wired wall controller 2600 is still available). The loading dock personnel can then utilize the buttons 2604 to affect the provisioning operation.

The dock controller 140 described herein may be configured to operate in a similar manner as the wired wall controller 2600, e.g., allowing loading dock personnel to provision the movable barrier operator 2614 without the wired wall controller 2600 present and/or without the cable 2606 from the wired wall controller 2600 actively coupled to the terminal 2612 of the movable barrier operator 2614.

In some implementations, the dock controller 140 includes wires 2618A, 2618B. The wires 2618A, 2618B may be contained in a jacket. Each of the wires 2618A, 2618B can include a central conductor 2620A, 2620B (e.g., an electrically conductive wire), which, when electrically connected to communication circuitry, such as a terminal 2612 defined by an associated movable barrier operator 2614, forms a two wire-circuit, allowing loading dock personnel to control the motor 2616 to raise and lower the movable barrier using the dock controller 140. Yet further, the movable barrier operator 2614 can be provisioned using the dock controller 140 without the wired wall controller 2600 electrically connected to the movable barrier operator 2614.

In an embodiment, the dock controller 140 can be configured to emulate the wired wall controller 2600. For example, the display 168 can be controlled to display icons 302 that are selectable by loading dock personal to provide control functionality for the movable barrier operator 2614. The depicted icons 302 include an up-arrow icon, a down-arrow icon, and a stop icon. When one of the icons 302 is selected, the dock controller 140 can generate a signal which is transmitted through wires 2618A, 2816B to the movable barrier operator 2614 to affect control of the movable barrier operator 2614, including provisioning control.

In some implementations, the dock controller 140 can be configured to detect the type of movable barrier operator 2614 (e.g., manufacturer, model number, etc.) and self-configure to emulate a wired wall controller associated with the detected type of movable barrier operator 2614. By way of non-limiting example, the dock controller 140 can transmit a probe or test signal to a connected device (e.g., through the wires 2618A and/or 2618B) and measure one or more response characteristics (e.g., voltage, current profile, impedance, back-EMF, etc.). The dock controller 140 can then compare the response to one or more stored profiles to identify the attached device or to identify a device class. A lookup table can be stored in memory of the dock controller 140. The lookup table can include information associated with characteristics of different wired wall controllers (e.g., button count, button functionality, button layout, etc.) and their associated moveable barrier operators. When a particular moveable barrier operator is detected, the lookup table is cross-referenced to determine the associated characteristics of the associated wired wall controller. The display 168 can then be affected accordingly. With the device or device class identified, the dock controller 140 can execute a control routine appropriate for that device or device type. For example, where the movable barrier operator 2614 is determined to be associated with a two-button wired wall controller, the display 168 can be affected to display two icons 302. The displayed icons may be sized and/or shaped to mimic the buttons on the associated wired wall controller.

Dock controllers described herein may be suitable for human-operated facilities (e.g., facilities that are manually operated by loading dock personnel), dark warehouses (e.g., facilities that are operated by robotic equipment), and semi-dark warehouses (e.g., facilities that are operated by a combination of loading dock personnel and robotic equipment). The dock controllers may work together to perform some operations and separately to perform other operations. For example, the dock controllers may provide individual management of loading dock components associated with their loading dock while simultaneously providing global security and safety to the loading dock area. Where a global security or safety issue arises, the dock controllers can work together, e.g., using machine learning (ML), to solve the issue. Where a solution is not achievable without human intervention, the dock controller(s) may create a notification or trigger a warning that pushes the issue upstream to a human operator. The human operator need not be present onsite but may instead be located in another city, another state, or even another country. The human operator may triage the issue and arrange for onsite personnel to provide onsite technical assistance.

Computational components and internet of things (IoT) devices described herein can rely on one or more processors and memory to operate. The processor(s) can be any suitable processing device (e.g., a control circuitry, a processor core, a microprocessor, an application specific integrated circuit, a field programmable gate array, a controller, a microcontroller, etc.) and can be one processor or a plurality of processors that are operatively connected, locally or remotely. The memory can include one or more non-transitory computer-readable storage media, such as RAM, ROM, EEPROM, EPROM, one or more memory devices, flash memory devices, etc., and combinations thereof. The memory can store information that can be accessed by the processor(s). For instance, the memory (e.g., one or more non-transitory computer-readable storage mediums, memory devices) can include computer-readable instructions that can be executed by the processor(s). The instructions can be software, firmware, or both written in any suitable programming language or can be implemented in firmware or hardware. Additionally, or alternatively, the instructions can be executed in logically and/or virtually separate threads on processor(s). For example, the memory can store instructions that when executed by the processor(s) cause the processor(s) to perform operations such as any of the operations and functions as described herein.

Further aspects of the disclosure are provided by one or more of the following embodiments:

A dock controller for a loading dock environment, the dock controller comprising: a base; a cover coupled to the base, the base and cover defining an internal volume; control circuitry disposed in the internal volume, the control circuitry configured to affect control of loading dock component in the loading dock environment; and a camera disposed within the internal volume and configured to capture a field of view (FOV) of the loading dock environment.

The dock controller of any one or more of the embodiments, wherein the camera is coupled to the cover through a bracket, and wherein at least a portion of the bracket is repositionable relative to the cover to affect different camera FOVs of the loading dock environment.

The dock controller of any one or more of the embodiments, wherein the cover defines an opening, wherein the FOV of the loading dock environment is viewed through the opening, and wherein the opening is covered by a screen.

The dock controller of any one or more of the embodiments, wherein the camera is configured to generate image data, and wherein the image data is transmittable from the dock controller to a remote location for remote viewing of the image data.

The dock controller of any one or more of the embodiments, further comprising a display, wherein image data captured by the camera is viewable at the display.

The dock controller of any one or more of the embodiments, wherein the dock controller comprises a credentialing device, and wherein displaying the image data on the display requires presentation of a valid credential at the credentialing device.

The dock controller of any one or more of the embodiments, wherein the camera is configured to capture image data, wherein a processor of the dock controller is configured to detect issues at the loading dock environment based at least in part on the image data, and wherein the dock controller is configured to generate a notification at a display of the dock controller in view of a detected issue.

A loading dock environment comprising a plurality of dock controllers of claim 1, wherein the FOVs of cameras associated with adjacent dock controllers at least partially overlap one another.

The loading dock environment of any one or more of the embodiments, wherein a processor is configured to stitch together image data from at least two of the cameras to provide an enlarged view of the loading dock environment.

The dock controller of any one or more of the embodiments, wherein the cover supports a display and a touch interface that receives a user input to control functionality of the loading dock component.

The dock controller of any one or more of the embodiments, wherein the cover defines a field configured to removably receive a user interface associated with control of one or more loading dock component.

The dock controller of any one or more of the embodiments, wherein the dock controller further comprises a display configured to provide instructions for installing the user interface at the field, using the user interface, or a combination thereof.

The dock controller of any one or more of the embodiments, wherein the field is disposed at a vertical elevation below the camera, and wherein a user interface control board to which the user interface is electrically connected to enable use of the user interface is coupled to the cover within the internal volume.

The dock controller of any one or more of the embodiments, wherein the cover is movable between open and closed positions relative to the base via one or more hinges, and wherein the camera moves with the cover.

A loading dock environment comprising: a first movable barrier operator having a first motor configured to drive a first movable barrier between an open position and a closed position; a second movable barrier operator having a second motor configured to drive a second movable barrier between an open position and a closed position; a first dock controller operatively coupled to the first movable barrier operator to affect operation of the first motor; and a second dock controller operatively coupled to the second movable barrier operator to affect operation of the second motor; wherein the first and second dock controllers each includes a camera disposed in an internal volume of the respective dock controller, wherein each camera is configured to capture a field of view (FOV) of the loading dock environment, and wherein the FOVs at least partially overlap one another.

The loading dock environment of any one or more of the embodiments, wherein the camera of the first dock controller is coupled to a cover of the first dock controller via a bracket, and wherein at least a portion of the bracket is repositionable relative to the cover to affect different camera FOVs of the loading dock environment.

The loading dock environment of any one or more of the embodiments, wherein the cameras of the first and second dock controllers are configured to generate image data of the loading dock environment, wherein a processor of at least one of the first and second dock controllers is configured to detect issues at the loading dock environment based at least in part on the image data, and wherein at least one of the first and second dock controllers is configured to generate a notification at a display of the respective dock controller in view of the detected issue.

The loading dock environment of any one or more of the embodiments, wherein the first dock controller comprises a display, and wherein image data captured by the camera of the first dock controller is viewable at the display.

A method of operating a dock controller in a loading dock environment, the method comprising: capturing image data, via a camera disposed in an internal volume of a dock controller, associated with the loading dock environment; analyzing, by a processor of the dock controller or a remote computing device, the image data to detect occurrence of an issue at the loading dock environment; generating, by the processor, a notification in response to a detected issue; and displaying, via a display of the dock controller, the notification, the image data, or a combination thereof.

The method of any one or more of the embodiments, further comprising transmitting information associated with the image data to the remote computing device; and storing the information at a memory.

This written description uses examples to disclose the invention, including the best mode, and also to enable any person skilled in the art to practice the invention, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Reference is made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Facilities described herein may correspond to various shipping nodes that freight may pass through during a journey between two endpoints. The term “loading dock” is used herein to describe an entry point into the facility through which freight is moved. In some applications, loading docks may be referred to as shipping docks, receiving docks, loading bays, warehouse docks, freight docks, cargo bays, transport docks, logistics docks, loading terminals, port docks, air freight terminals, rail freight yards, or the like. Loading docks may include attached and/or adjoining warehouse space where freight removed from a previous vehicle is stored, temporarily or long term, for later distribution.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A dock controller for a loading dock environment, the dock controller comprising:
a base;
a cover coupled to the base, the base and cover defining an internal volume;
control circuitry disposed in the internal volume, the control circuitry configured to affect control of a loading dock component in the loading dock environment; and
a camera disposed within the internal volume and configured to capture a field of view (FOV) of the loading dock environment.

2. The dock controller of claim 1, wherein the camera is coupled to the cover through a bracket, and wherein at least a portion of the bracket is repositionable relative to the cover to affect different camera FOVs of the loading dock environment.

3. The dock controller of claim 1, wherein the cover defines an opening, wherein the FOV of the loading dock environment is viewed through the opening, and wherein the opening is covered by a screen.

4. The dock controller of claim 1, wherein the camera is configured to generate image data, and wherein the image data is transmittable from the dock controller to a remote location for remote viewing of the image data.

5. The dock controller of claim 1, further comprising a display, wherein image data captured by the camera is viewable at the display.

6. The dock controller of claim 5, wherein the dock controller comprises a credentialing device, and wherein displaying the image data on the display requires presentation of a valid credential at the credentialing device.

7. The dock controller of claim 1, wherein the camera is configured to capture image data, wherein a processor of the dock controller is configured to detect issues at the loading dock environment based at least in part on the image data, and wherein the dock controller is configured to generate a notification at a display of the dock controller in view of a detected issue.

8. A loading dock environment comprising a plurality of dock controllers of claim 1, wherein the FOVs of cameras associated with adjacent dock controllers at least partially overlap one another.

9. The loading dock environment of claim 8, wherein a processor is configured to stitch together image data from at least two of the cameras to provide an enlarged view of the loading dock environment.

10. The dock controller of claim 1, wherein the cover supports a display and a touch interface that receives a user input to control functionality of the loading dock component.

11. The dock controller of claim 1, wherein the cover defines a field configured to removably receive a user interface associated with control of one or more loading dock component.

12. The dock controller of claim 11, wherein the dock controller further comprises a display configured to provide instructions for installing the user interface at the field, using the user interface, or a combination thereof.

13. The dock controller of claim 11, wherein the field is disposed at a vertical elevation below the camera, and wherein a user interface control board to which the user interface is electrically connected to enable use of the user interface is coupled to the cover within the internal volume.

14. The dock controller of claim 1, wherein the cover is movable between open and closed positions relative to the base via one or more hinges, and wherein the camera moves with the cover.

15. A loading dock environment comprising:
a first movable barrier operator having a first motor configured to drive a first movable barrier between an open position and a closed position;
a second movable barrier operator having a second motor configured to drive a second movable barrier between an open position and a closed position;
a first dock controller operatively coupled to the first movable barrier operator to affect operation of the first motor; and
a second dock controller operatively coupled to the second movable barrier operator to affect operation of the second motor;
wherein the first and second dock controllers each includes a camera disposed in an internal volume of the respective dock controller, wherein each camera is configured to capture a field of view (FOV) of the loading dock environment, and wherein the FOVs at least partially overlap one another.

16. The loading dock environment of claim 15, wherein the camera of the first dock controller is coupled to a cover of the first dock controller via a bracket, and wherein at least a portion of the bracket is repositionable relative to the cover to affect different camera FOVs of the loading dock environment.

17. The loading dock environment of claim 15, wherein the cameras of the first and second dock controllers are configured to generate image data of the loading dock environment, wherein a processor of at least one of the first and second dock controllers is configured to detect issues at the loading dock environment based at least in part on the image data, and wherein at least one of the first and second dock controllers is configured to generate a notification at a display of the respective dock controller in view of the detected issue.

18. The loading dock environment of claim 15, wherein the first dock controller comprises a display, and wherein image data captured by the camera of the first dock controller is viewable at the display.

19. A method of operating a dock controller in a loading dock environment, the method comprising:
capturing image data, via a camera disposed in an internal volume of a dock controller, associated with the loading dock environment;
analyzing, by a processor of the dock controller or a remote computing device, the image data to detect occurrence of an issue at the loading dock environment;
generating, by the processor, a notification in response to a detected issue; and
displaying, via a display of the dock controller, the notification, the image data, or a combination thereof.

20. The method of claim 19, further comprising
transmitting information associated with the image data to the remote computing device; and
storing the information at a memory.
